(19) United States
(12) Patent Application Publication
(10) Pub. No.: US 2026/0261478 A1
(43) Pub. Date: Sep. 3, 2026

(54) Standardized Power Measurements with Increased Accuracy

(71) Applicant: Cisco Technology, Inc., San Jose, CA (US)

(72) Inventors: Joel Richard Goergen, Soulsbyville, CA (US); Elizabeth Ann Kochuparambil, Morgan Hill, CA (US); Alpesh U Bhobe, Sunnyvale, CA (US); Sean Carlos Pegado, Washington, DC (US); Marc Henry Mantelli, Morgan Hill, CA (US); Angelo Fienga, Rome (IT); Fitim Sallahu, Jönköping (SE); Kameron Rose Hurst, Sonora, CA (US); Hrishikesh Shekhar Pawar, Karnataka (IN)

(21) Appl. No.: 19/652,591

(22) Filed: Apr. 20, 2026

Related U.S. Application Data
(63) Continuation-in-part of application No. 19/209,616, filed on May 15, 2025.
Application No. 19/209,616 is a continuation of application No. 18/418,161, filed on Jan. 19, 2024, now Pat. No. 12,526,191.

(30) Foreign Application Priority Data
Sep. 14, 2023 (IN) 202321061950

(51) Int. Cl. H04L 41/0833; H04L 43/08

(52) U.S. Cl. CPC H04L 41/0833; H04L 43/08

(57) ABSTRACT

Systems and methods for modular power characterization and predictive sustainability optimization are described herein. The system includes a testing environment configured to generate a library of modular component characterizations, such as fractional power scaling data for individual radios under controlled thermal stressors. A sustainability logic retrieves this modular data to model a cumulative power sum for a projected network topology, accounting for dynamic variables like signal attenuation across multi-hop paths. The system further integrates heterogeneous platforms by normalizing power data across compute and networking layers into a unified sustainability metric using high-fidelity real-time telemetry. A multifactor optimization engine processes the modeled signal paths against business and environmental needs to determine a return on energy metric. Ultimately, the system automatically identifies specific architectural changes to a customer install base required to meet a predetermined sustainability target, such as a net-zero emissions goal.

### PRIORITY

This application is a Continuation-In-Part on U.S. Patent Application No. 19/209,616, filed May 15, 2025, and a continuation of U.S. Application No. 18/418,161, now U.S. Patent No. 12,526,191 issued Jan. 13, 2026, and claims the benefit of and priority of Indian Provisional patent application Serial No. 2023/21061950, filed Sep. 14, 2023, the disclosure of which is incorporated by reference herein in its entirety.

### FIELD

The present disclosure relates to power measurements. More particularly, the present disclosure relates to standardizing power measurements to provide more accurate power readings.

### BACKGROUND

Power verification in both AC and DC input systems involves the measurement of various electrical parameters to ensure proper functioning and compliance with specifications. In AC power systems, essential measurements include voltage, current, power factor, and frequency. Voltage is typically measured using voltmeters, while current is measured with ammeters. Power factor, representing the phase relationship between voltage and current, is evaluated to assess the efficiency of power utilization. Frequency, crucial for synchronized operation, is measured using frequency meters.

In DC power systems, voltage and current measurements remain fundamental, usually performed using multimeters. Additionally, power in DC systems can be determined using the product of voltage and current. To ensure accuracy and reliability, advanced measurement instruments such as power analyzers may be employed in both AC and DC systems, offering comprehensive insights into parameters like harmonic content and total harmonic distortion. The verification process involves comparing measured values with design specifications to identify any deviations and address potential issues, ensuring the system's optimal performance and adherence to operational standards.

However, measurement methods for power verification in AC or DC input power are often over simplified or done with a method that achieves inaccurate or highly suspect results. It can be verified easily that engineering labs or customer labs use different methods for the same device to be verified, resulting in lack of consistency and any sense of accuracy and/or relevance. Further compounding the problem is that any read done by software of and input voltage/current or output voltage/current has a accuracy of +/-20% to +/-50%, depending on the power loading and the component choice/layout doing the measurement, as well as the fact that command line interfaces/software I2C readings of these values are instantaneous and not an RMS or basic average seen in a typical volt ohm meter. Furthermore, read values don't often have a point of normalization as reference to dynamically point out or address accuracy of the readings. Finally, because the data gathered is extremely inaccurate, customers don't have a valid means of calculating carbon footprints, and examining operating range trade-offs to correctly size and operate equipment to a specific operating environment.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual illustration of various power measurements, in accordance with various embodiments of the disclosure;

FIG. 2 is a conceptual illustration of a command line interface, in accordance with various embodiments of the disclosure;

FIG. 3A is a conceptual illustration of an efficiency curve, in accordance with various embodiments of the disclosure;

FIG. 3B is a graph depicting an exemplary power vs. real power, in accordance with various embodiments of the disclosure.

FIG. 4A is a graph depicting an exemplary power sharing arrangement between two devices, in accordance with various embodiments of the disclosure;

FIG. 4B is a conceptual schematic of a power sharing arrangement, in accordance with various embodiments of the disclosure;

FIG. 5 is a conceptual illustration of a measurement process, in accordance with various embodiments of the disclosure;

FIG. 6 is a conceptual illustration of a standardized power usage chart, in accordance with various embodiments of the disclosure;

FIG. 7 is a conceptual illustration of utilizing standardized power usage charts to execute network management decisions, in accordance with various embodiments of the disclosure;

FIG. 8 is a conceptual network diagram of various embodiments that a sustainability logic may operate, in accordance with various embodiments of the disclosure;

FIG. 9 is a flowchart depicting a process for generating standardized power usage data, in accordance with various embodiments of the disclosure;

FIG. 10 is a flowchart depicting a process for generating standardized power usage charts, in accordance with various embodiments of the disclosure;

FIG. 11 is a flowchart depicting a process for conducting measurements to generate standardized power usage data, in accordance with various embodiments of the disclosure;

FIG. 12 is a conceptual block diagram of a device suitable for configuration with a sustainability logic, in accordance with various embodiments of the disclosure;

FIG. 13 is a block diagram illustrating a modular radio characterization test setup for isolating individual component power impacts;

FIG. 14 is a schematic diagram illustrating a network topology and signal path for predictive power modeling in a distributed ecosystem;

FIG. 15 is a block diagram illustrating a measurement architecture for mixed compute and wireless platforms within a heterogeneous environment;

FIG. 16 is a block diagram illustrating an automated wireless test bed and standardization environment for generating power usage data;

FIG. 17 is a flowchart illustrating a manually driven logic flow for estimating costs and relevant energy savings based on a customer install base; and

FIG. 18 is a flowchart illustrating an automated multifactor optimization engine flow for identifying architectural changes to meet a sustainability target.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

### Overview

In some embodiments, an apparatus includes a processor, a testing chamber, and a memory communicatively coupled to the processor, wherein the memory includes a sustainability logic. The logic is configured to direct the testing chamber to establish a predetermined temperature, generate a fractional traffic load for a unit under test including a plurality of radios, operate the unit under test within the testing chamber to simulate signal degradation, generate a standardized power-vs-temperature table specific to wireless radio activity for the unit under test, and synchronize the standardized power-vs-temperature table with a cloud-based network simulator.

In some embodiments, a method of network sustainability optimization includes retrieving, by a device, data representing a customer install base, retrieving a library of modular component characterizations, modeling a cumulative power sum for a projected network topology, determining a return on energy metric by processing the modeled signal path against real-time telemetry from the customer install base, and identifying one or more architectural changes to the customer install base required to meet a predetermined sustainability target.

### Example Embodiments

In response to the issues described above, devices and methods are discussed herein that standardize power usage data. As a result of the problems and issues described above, an over payment of carbon tax and energy use can occur. In response, embodiments are described below to achieve a more accurate carbon footprint in the appropriate operating environment based on need, customer, and location. These standardized power usage charts can be generated to better select network devices or other components for use, and may be utilized in various decision-making actions when managing a network, such as, but not limited to, directing traffic to lower power using devices.

As those skilled in the art will recognize, different companies within various markets can, and often do, measure power in various ways. In some embodiments, a command line interface or a current clamp can be utilized. In some cases, the use of uncalibrated and/or inaccurate power meters can occur. However, some accurate methods can be utilized such as a Chroma power measurement method. However, measurement methods may be applied inconsistently even within the same group and/or company, and may even change depending on the day or personnel on staff. As a result, there is often no accuracy or consistency across data sheet power values or power calculator tools.

Various temperature ranges can provide effective coverage of reasonable system operation for relative comparisons across various deployments and installations. For example, room temperature of twenty-three degrees Celsius can allow for fast analysis and verification. An acoustic measurement temperature of twenty-seven degrees Celsius may also be utilized. In many embodiments, the maximum normal operating temperature can be forty degrees Celsius. Systems may run much hotter in certain applications, but those higher temperatures may be considered a fault case scenario. For certain embodiments, such as those specific systems like internet of things (IoT) or the like, can be tested at a fifty-degree Celsius temperature.

Regarding traffic patterns, in various embodiments, the system can be stabilized for five minutes running the traffic pattern at the desired temperature prior to measuring the power usage. If the power measurement is stable over the next minute, then that temperature may be selected for use. When it is not stable, another time period (such as a minute) may be waited prior to taking another measurement and seeing that shows a stabilization between the prior measurement(s). In some embodiments, the power measurement can be considered stable only when a fan tray variance is found to occur. This variance can be understood as taking the average between the high measurement and the low measurement. In more embodiments, temperatures can have a thirty-minute dwell time, followed by a thirty-minute to sixty-minute settling time. When handling jumps between temperature ranges, a waiting period may be utilized for stabilization. It may be desired for temperature and power to stabilize for thirty minutes.

In regard to traffic test set-ups, a max port speed for the test can be defined. This may be appropriate for optical and/or copper cabling modules and systems. For certain configurations, traffic patterns may be randomized by packet size. In some embodiments, the randomization can be from 64 bytes to 9216 bytes. In additional embodiments, the randomization can be between 64 bytes and 1518 bytes. However, as those skilled in the art will recognize, any type of packet size may be utilized as needed. In still more embodiments, the average customer feature set can be defined and set with random data and sizes based on the input security, input quality of service classifiers, egress security, or the like.

Additionally, it is recognized that the terms “power” and “energy” are often used interchangeably in many colloquial settings but have distinct differences. Specifically, energy is accepted as the capacity of a system or device to do work (such as in kilowatt-hours (kWh)), while power is the rate at which energy is transferred (often in watts (W)). Power represents how fast energy is being used or produced. With this in mind, it should be understood that various elements of the present disclosure may utilize common terms like “power lines,” “power grids,” power source,” “power consumption,” and “power plant” when describing energy delivery and utilization, even though those skilled in the art will recognize that those elements are delivering or processing energy (specifically electricity) at a certain rate of power. References to these terms are utilized herein specifically to increase the ease of reading.

Those skilled in the art will recognize that the generation of electricity within the various power plants often creates some pollution or, more generally, one or more negative environmental impacts, which can often come in the form of emissions. However, these negative environmental impacts can come in a variety of forms including, but not limited to, land use, ozone depletion, ozone formation inhibition, acidification, eutrophication (freshwater, marine, and terrestrial), abiotic resource depletion (minerals, metals, and fossil fuels), toxicity, water use, negative soil quality change, ionizing radiation, hazardous waste creation, etc. As such, these negative environmental impact measurements can be measured with specific units to quantify these changes. Various aspects of energy use can be associated with one or more of these negative environmental impacts and classified as one or more sustainability-related attributes. Embodiments described herein can be utilized to reduce the overall negative environmental impacts through the generation of standardized power usage data and charts.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.”. An exception to this definition will occur only when a combination of elements, functions, steps, or acts are in some way inherently mutually exclusive.

Aspects of the present disclosure are described below with reference to schematic flowchart diagrams and/ or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

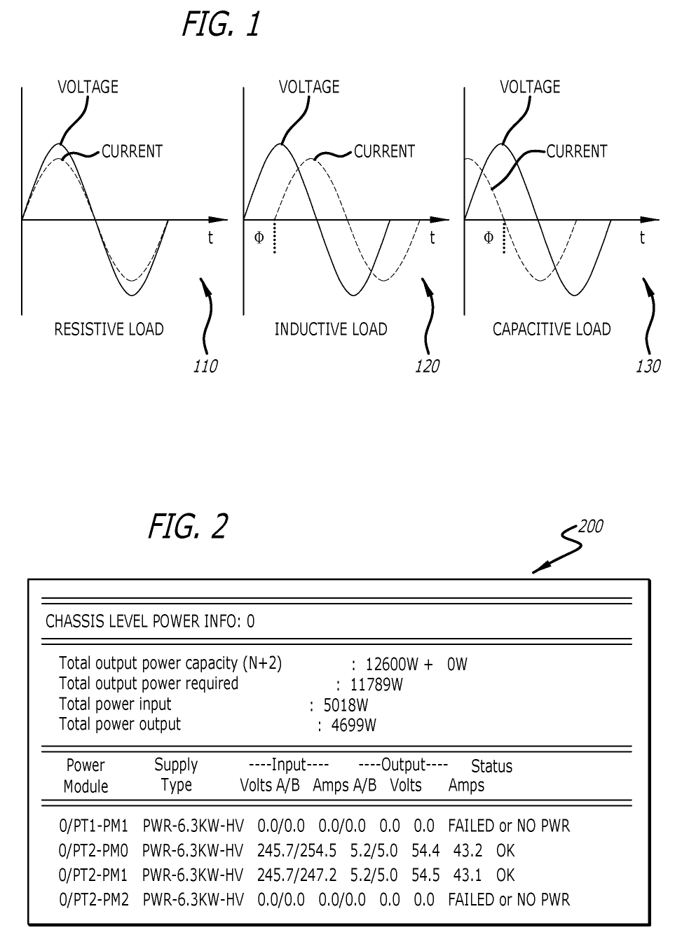

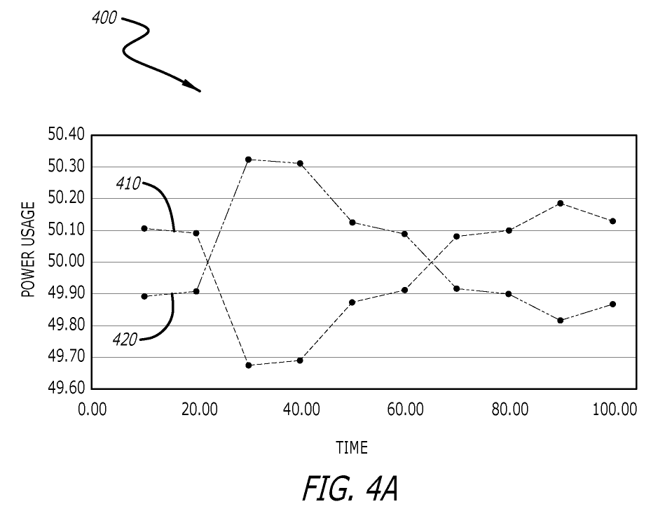

Referring to FIG. 1, a conceptual illustration of various power measurements, in accordance with various embodiments of the disclosure is shown. As those skilled in the art will recognize, power is typically defined as volts multiplied by amperes. However, that calculation is typically only true with resistive loads. Various embodiments described herein can be configured with a plurality of capacitive loads. In light of that, power may alternatively be defined as volts multiplied by both current and the cosine of phi which can indicate how much power is lost during the “transport” of power, which is often known as a power factor. This formula can indicate the actual power used. The embodiment depicted in FIG. 3, depicts multiple loads including a resistive load 110, an inductive load 120, and a capacitive load 130. The offset is denoted by the Greek symbol phi, which is the previously described power factor.

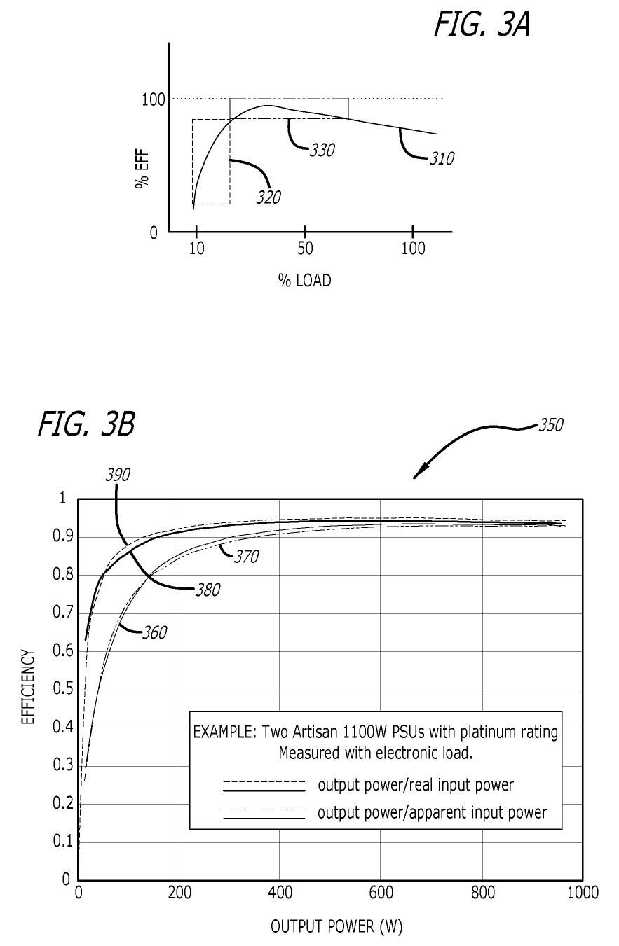

Although a specific embodiment for various power measurements suitable for carrying out the various steps, processes, methods, and operations described herein is discussed with respect to FIG. 1, any of a variety of systems and/or processes may be utilized in accordance with embodiments of the disclosure. For example, the loads depicted in FIG. 1 are simplified for ease of illustration and may be different or more complex in various embodiments. The elements depicted in FIG. 1 may also be interchangeable with other elements of FIGS. 2–18 as required to realize a particularly desired embodiment.

Referring to FIG. 2, a conceptual illustration of a command line interface, in accordance with various embodiments of the disclosure is shown. In many traditional systems, a command line interface 200 may be utilized to respond to a query about the current power values of various components and/or systems. However, traditional command line interfaces can generate reports with significant errors, in some cases up to twenty-five percent over or under the actual values. In embodiments where the power factor is less than 0.5, the errors generated by the command line interfaces can increase significantly. As various embodiments, methods, and systems described herein are often configured to operate with a power factor of less than 0.3, these issues can be exacerbated.

Although a specific embodiment for a command line interface suitable for carrying out the various steps, processes, methods, and operations described herein is discussed with respect to FIG. 2, any of a variety of systems and/or processes may be utilized in accordance with embodiments of the disclosure. For example, the command line interface may be presented in a graphical user interface depending on the deployment. Additionally, the data presented in the command line interface. may be formatted differently or may have more or less data displayed and/or collected. The elements depicted in FIG. 2 may also be interchangeable with other elements of FIGS. 1 and 3A-18 as required to realize a particularly desired embodiment.

Referring to FIG. 3A, a conceptual illustration of an efficiency curve, in accordance with various embodiments of the disclosure is shown. As those skilled in the art will further recognize, power efficiency can be calculated as the power out divided by the power in. However, this is often only true with resistive loads. Again, various embodiments described herein are configured to primarily utilize capacitive loads. Power efficiency may be alternatively defined as equal to the power out divided by the real power in. This equation can be considered to be the “actual” power efficiency. Because of the measurement error from command lines, such as those previously described in the discussion FIG. 2, the power values reported cannot be used for a proper efficiency analysis.

In the embodiment depicted in FIG. 3A, the chart 300 shows a conceptual “typical” curve 310 associated with the efficiency of a device over a percentage of the load provided. The curve 310 is shown with a first power efficiency area 320, labeled as a “worst case operation” and a second power efficiency area 330, which is labeled as “optimal operation”. As more load is added to the device, the curve 310 increase until it leaves the first power efficiency area 320 and enters the more optimal second power efficiency area 330. Eventually, a peak point where the curve 310 enters the highest efficiency is reached. As more load is added, the curve 310 can slowly decrease the efficiency.

Referring to FIG. 3B, a graph depicting an exemplary power vs. real power, in accordance with various embodiments of the disclosure is shown. The embodiment depicted in FIG. 3B is associated with two real devices. The chart 350 is similar to the chart 300 depicted in FIG. 3A, with an exception that the efficiency of a device is charted against the output power of the device (in Watts) instead of a percentage of the load provided. The first pair of curves 360, 370 are associated with a first power supply, while the second pair of curves 380, 390 are associated with a second power supply. Regarding the first pair of curves 360, 370, one curve 360, is associated with the output power of the first power supply, while the second curve 370 is associated with the real input power of the first power supply. Likewise, the first curve 380 of the second pair of curves 380, 390, is associated with the output power of the second power supply, while the second curve 390 is associated with the real input power of the second power supply.

Although specific embodiments for efficiency and power curves suitable for carrying out the various steps, processes, methods, and operations described herein is discussed with respect to FIGS. 3A–3B, any of a variety of systems and/or processes may be utilized in accordance with embodiments of the disclosure. For example, the types of graphs utilized may vary depending on the application desired. Additionally, more, or fewer items may be measured to determine various efficiency or output power levels. The elements depicted in FIGS. 3A–3B may also be interchangeable with other elements of FIGS. 1–2 and 4A–18 as required to realize a particularly desired embodiment.

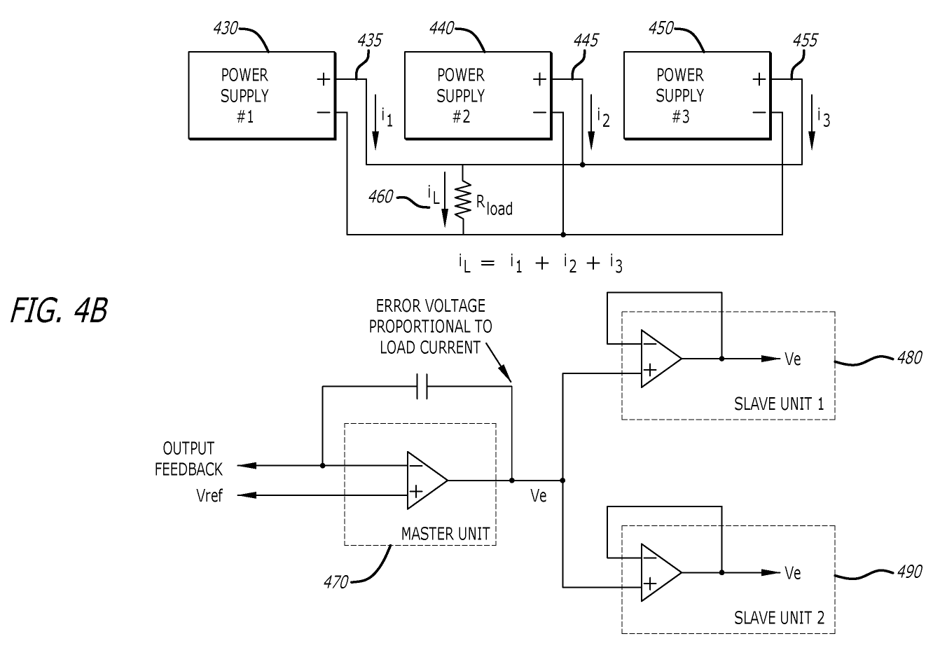

Referring to FIG. 4A, a graph depicting an exemplary power sharing arrangement between two devices, in accordance with various embodiments of the disclosure is shown. “Current Share” (often denoted as “I-Share”) is a function (often analog) that allows a plurality of power supplies to contribute output power in an equal manner. In many embodiments, the I-share output power can be up to plus/minus ten percent. I-Share can have multiple disadvantages associated with determining a power factor. Firstly, in dual supply applications, the supplies can contribute sixty/forty, where one supply now has a lower power factor with more measurement error. Secondly, the power sharing can reverse unexpectedly. The embodiment depicted in FIG. 4, shows a graph 400 of two power supplies denoted by a first line 410 and a second line 420. The first line 410 and second line 420 denote the power output over time of the two power supplies. Each of the supplies outputs power at various levels such that they equal a given shared level. As can be seen, as one power supply outputs less power, the other power supply outputs more power, and vice-versa.

Referring to FIG. 4B, a conceptual schematic of a power sharing arrangement, in accordance with various embodiments of the disclosure is shown. The embodiment depicted in FIG. 4B shows a schematic arrangement for an I-Share system. A first power supply 430, second power supply 440, and a third power supply 450. The first power supply 430 is associated with a first current 435 (shown as i1), the second power supply 440 is associated with a second current i2 445, and the third power supply 450 is associated with a third current i3 455. A load current iL 460 can be determined by adding up the first current 435, second current 445, and third current 455. This can be utilized in an I-Share scenario. Likewise, a master unit 470 is electrically connected to a first slave unit 480 and a second slave unit 490. As highlight in FIG. 4B, the error voltage can be proportional to the load current.

Although specific embodiments for power sharing arrangements suitable for carrying out the various steps, processes, methods, and operations described herein is discussed with respect to FIGS. 4A–4B, any of a variety of systems and/or processes may be utilized in accordance with embodiments of the disclosure. For example, the specific layout or schematic of a shared load or other I-share setup may vary depending on the specific deployment utilized or the overall application desired. The embodiments shown herein are utilized for illustrative purposes and are not meant to be limiting to those specific configurations. The elements depicted in FIGS. 4A–4B may also be interchangeable with other elements of FIGS. 1–3B and 5–18 as required to realize a particularly desired embodiment.

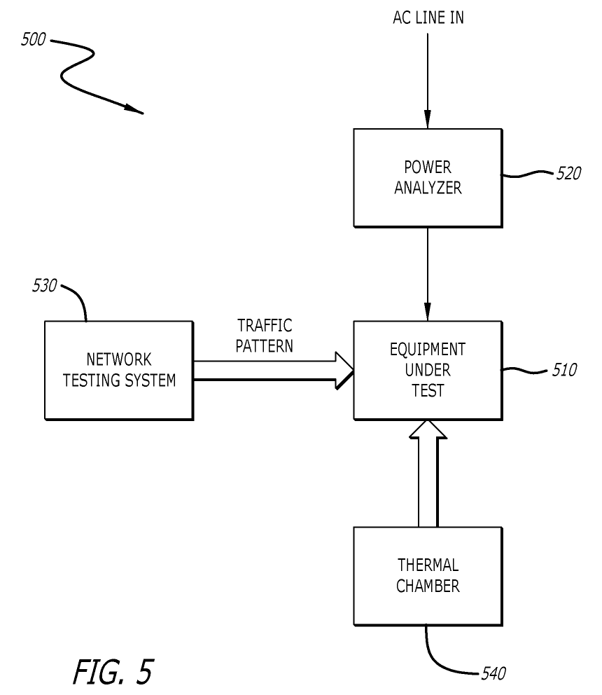

Referring to FIG. 5, a conceptual illustration of a measurement process, in accordance with various embodiments of the disclosure is shown. In many embodiments described herein, the accurate measuring of power can be done in a plurality of steps. In the embodiment depicted in FIG. 5, the equipment under test 510 can include any type of network devices, components, power supplies, etc. Indeed, this process can be configured for a variety of different industries and/or environments. As previously discussed, the power is analyzed under various methods. The power analyzer 520 can be utilized as previously discussed and is as known in the art. However, as previous measuring methods have shown to be inadequate by themselves, various embodiments described herein can account and/or standardize or otherwise regulate the temperature and data rate when measuring power.

Certain embodiments can include four parts. In certain embodiments, the first part may include normalizing the load vs the power factor, efficiency, and I-Share curves. This can prevent significant errors in power supply units real power calculations and usage. In various embodiments, each power input line can be monitored for accurate analysis across the various influences. This can be done during the power analysis 520.

In a number of embodiments, the second part can include traffic pattern and packet rate data being utilized. This can be done through one or more network testing systems 530. Those skilled in the art will recognize that various network testing and visibility solutions can be utilized that are known within the market. These tests and data usage can include hardware and/or software tools configured for performance testing, security testing, network visibility, etc.

This data can be configured to stress the system in a manner similar to a typical deployed environment. In more embodiments, the data can be repeatable by a third party. For example, the data can be an Internet Mix, or “IMIX” data which can be configured as a specific combination of packet sizes and types that can simulate a realistic traffic mix on a network, device, component, etc.

In additional embodiments, the third part can include measuring at specific temperatures. The embodiment depicted in FIG. 5 utilizes a thermal chamber 540 which can be configured to control temperature during testing. Testing can be done at a variety of temperatures including, but not limited to, a room temperature test (around 23degrees Celsius), an acoustic comparative temperature (around 27degrees Celsius), a high-end normal temperature test (varies depending on the produced identification, model, etc.), and one or more tests that comports with a standardized body, such as the American Society of Heating, Refrigerating and Air-Conditioning Engineers (ASHRAE). For example, ASHRAE can conduct tests at 35, 40, 45, and 50 degrees Celsius.

In certain embodiments, a fourth part can include average the power sums across the various measurements. This can be accurate compared to, and translate easily to other testing methods, allows for defined packet testing, and can be easy to normalize and repeat. In some embodiments, the testing process can be automated and be completed in a matter of hours. This can allow testing for various network device and component types.

Although a specific embodiment for a measurement process suitable for carrying out the various steps, processes, methods, and operations described herein is discussed with respect to FIG. 5, any of a variety of systems and/or processes may be utilized in accordance with embodiments of the disclosure. For example, the specific order utilize may vary. In various embodiments, the testing may be done in one specialized device chamber. In additional embodiments, part of the testing may be utilized by a specialized device. The aspects described in FIG. 5 may also be interchangeable with other elements of FIGS. 1–4B and 6–18 as required to realize a particularly desired embodiment.

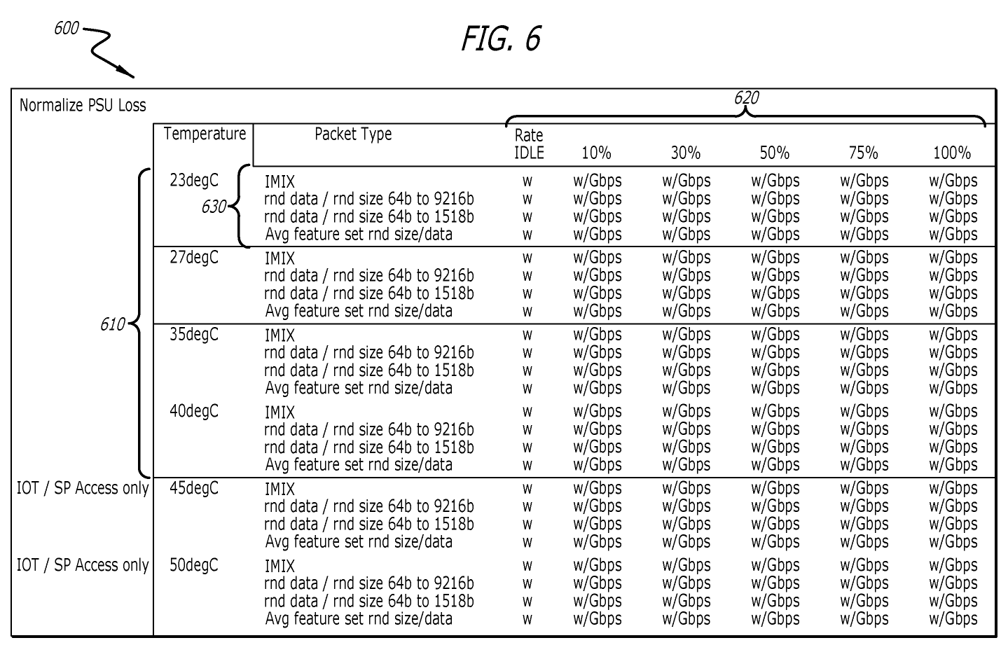

Referring to FIG. 6, a conceptual illustration of a standardized power usage chart, in accordance with various embodiments of the disclosure is shown. In many embodiments, a chart 600 can be generated for each network product, device, component, etc. The chart 600 can be configured to list a series of temperatures 610 that are unique and predetermined and a series of data rates 620. In various embodiments, the chart 600 may comprise four, six, or eight data sets. However, it is contemplated that the number of temperatures in the series of temperatures 610 and the number of data rates in the series of data rates 620 can vary based on the product, device, component, and/or desired application. The series of temperatures 610 can be configured to mimic typical operating environments for the devices, components, etc.

Each temperature in the series of temperatures 610 may comprise a plurality of packet types 630. These packet types can vary to illustrate differing network conditions. However, these packet types 630, as described above, can be standardized across the tests such that a useful comparison can be achieved. By way of non-limiting example, the series of data rates 620 can cover idle settings, ten-percent utilization, thirty-percent utilization, fifty-percent utilization, seventy-five percent utilization, and one-hundred-percent utilization, such as the embodiment shown in FIG. 6 has.

In a number of embodiments, various data is captured to generate the chart 600. This data can include, but is not limited to, voltage, current, real power, and the power factor for each device, component, etc. that is tested. In further embodiments, data can be captured for various components within a system and subsequently summed. In some embodiments, the chart 600 can be published showing the minimum power utilized, the average of the summed power, the maximum power utilized, a typical sum of the power (which is often the value published in data sheets). These values can be utilized to improve both the accuracy of the calculator and the overall software calculations of the max loading. In more embodiments, configuration factors can be utilized to extend the chart 600 for configurable systems and/or interchangeable product families.

Each plurality of packet types can vary but can be uniform across the series of temperatures 610 such that a more accurate comparison can be made. In the embodiment depicted in FIG. 6, the packet types 630 listed include an IMIX packet type, random data packets with a larger range of size, random data packets with a smaller range of size, and random data with a random size while having an average number of features enabled. However, as those skilled in the art will recognize, the specific data packet types 630 can vary depending on the application desired and the type of device, component, etc. that is being tested.

In additional embodiments, the results can be configured as a value associated with the watts of power utilized per gigabits per second. It is contemplated that other units of measurement may be utilized for different types of devices, etc. A minimum power value can be configured as the lowest power value across all of the sets. In more embodiments, a maximum power value can be configured as the highest power value across all of the series of temperatures 610 and the series of data rates 620. Likewise, in certain embodiments, a summation of the average power can be the sum of all power values across all temperature sets divided by the number of power values.

In still more embodiments, a typical power summation value can be configured as the sum of power values of each of the series of data rates 620 using one or more data packet types within a selected number of temperatures within the series of temperatures 610, divided by the number of power values in each series type. This can be configured to represent the realistic average operating range of a product in more applications. However, for devices, components, etc. that are configured for an internet of things (IoT) or other type device, can further include more extreme temperature values within the series of temperatures 610.

In numerous embodiments, the device being tested may have various components that can be tested themselves. For example, a server device, may have a plurality of cards, ports, or other components that may each be tested and then summed, etc. In these types of embodiments, a ‘per measurement’ data record can be generated. In addition to the packet types 630 depicted in FIG. 6, a port rate can be recorded, along with a port max rate, etc. For devices that have multiple power supplies, two or more instruments can be utilized to measure them.

As multiple devices within the same product line/family are tested, data can be accumulated to generate additional values. In certain embodiments, the previously tested data records can be utilized to generate a best-case or worst-case usage value. In some embodiments, the best-case value can be generated by dividing the minimum power value by the gigabits per second tested while the worst-case scenario may be generated by dividing the maximum power value by the gigabits per second tested. Additional data related to the state of the components of the devices may also be recorded and shared within the chart depending on the type of device being tested.

Although a specific embodiment for a standardized power usage chart suitable for carrying out the various steps, processes, methods, and operations described herein is discussed with respect to FIG. 6, any of a variety of systems and/or processes may be utilized in accordance with embodiments of the disclosure. For example, the “w/Gbps” listed in the embodiment shown in FIG. 6 may be replaced with actual values derived during the tests. In more embodiments, the format of the chart may vary depending on the device, component, etc. to be tested. The aspects described in FIG. 6 may also be interchangeable with other elements of FIGS. 1–5 and 7–8 as required to realize a particularly desired embodiment.

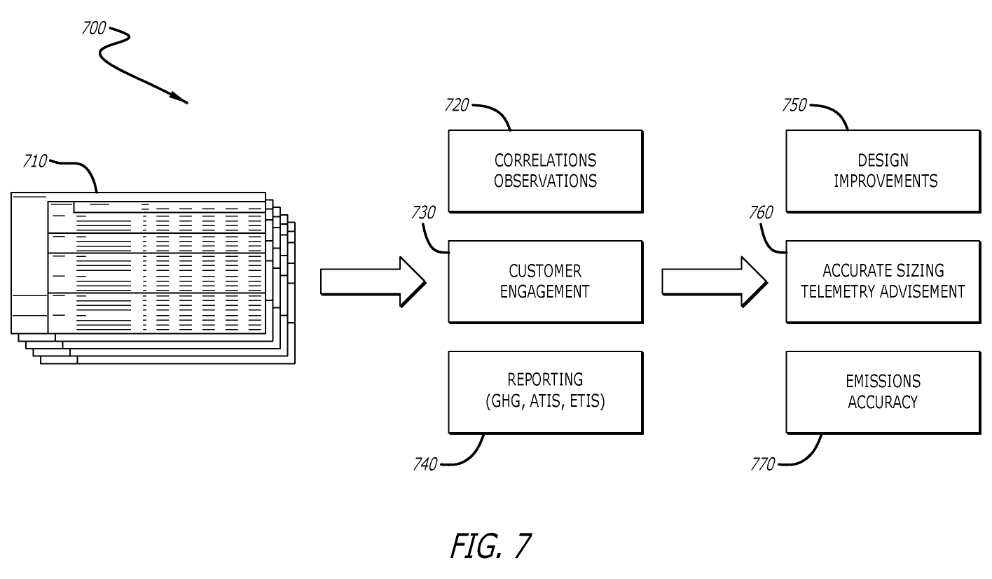

Referring to FIG. 7, a conceptual illustration of utilizing standardized power usage charts to execute network management decisions, in accordance with various embodiments of the disclosure is shown. In many embodiments, this data can be utilized in managing networks, such as to further achieve a goal of reducing carbon emissions. By utilizing accurate and repeatable power measurements, an actual decrease in the overall carbon footprint of a network can be achieved. For example, when given a choice on how to route a packet of data, a sustainability logic may examine the available power usage chart and route the packet along the path that utilizes less power to operate. In further embodiments, the sustainability logic may further cross-reference the available standardized power usage charts 710 with the current operating temperature and overall current telemetry to determine a more accurate estimate of the current power usage of the device being evaluated. In this way, more accurate routing and power usage decisions can be made.

The standardized power usage charts 710 can be utilized to generate various correlations and observations 720 about the actual power being used. Likewise, the standardized power usage charts can be disseminated to customers to create an increased customer engagement 730 with this new evaluation method. In further embodiments, the standardized power usage charts 710 can be provided to and perhaps utilized by various reporting and testing groups 740 (Global Holding Group, Alliance for Telecommunications Industry Solutions, The Community for Telecom Professionals, etc.).

Through this avenues of utilization, numerous benefits can occur. In a number of embodiments, the use of the standardized power usage charts 710 can lead to overall design improvements 750. In more embodiments, an accurate sizing/telemetry advertisement 760 can occur. Finally, as these changes occur across the industry, an overall increase in emissions accuracy 770 can occur, which will conversely bring down the overall rate of emissions released.

Although a specific embodiment for utilizing standardized power usage charts to execute network management decisions suitable for carrying out the various steps, processes, methods, and operations described herein is discussed with respect to FIG. 7, any of a variety of systems and/or processes may be utilized in accordance with embodiments of the disclosure. For example, the specific utilization or deployment of the standardized power usage charts can vary based on the available network, devices, or overall. market conditions. The aspects described in FIG. 7 may also be interchangeable with other elements of FIGS. 1–6 and 8–18 as required to realize a particularly desired embodiment.

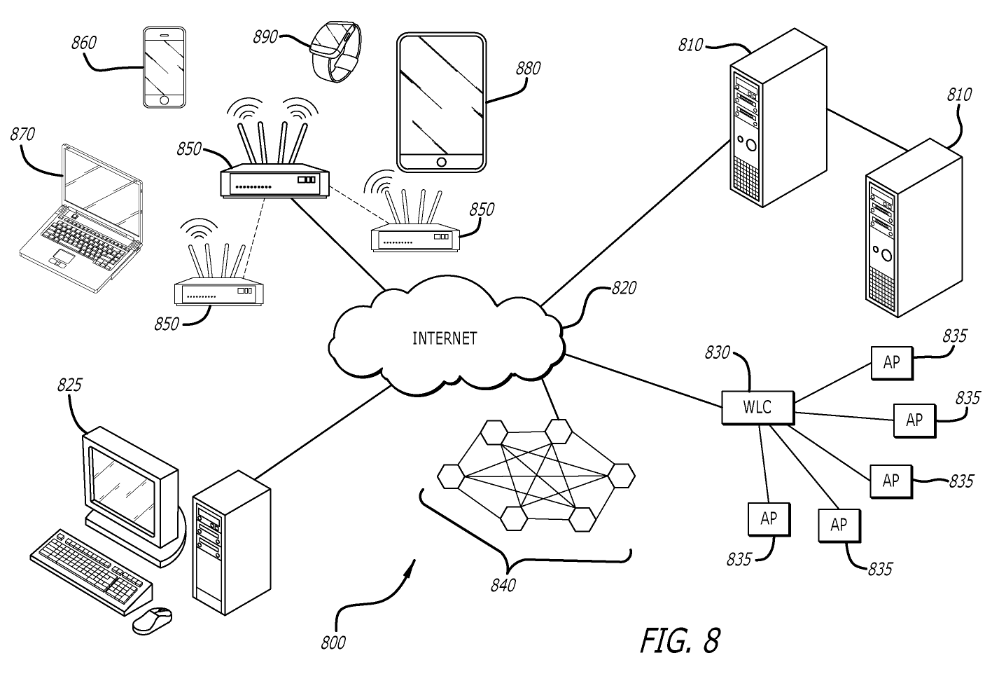

Referring to FIG. 8, a conceptual diagram of a network 800 of various environments that a sustainability logic may operate on a plurality of network devices, in accordance with various embodiments of the disclosure is shown. Those skilled in the art will recognize that the sustainability logic can be comprised of various hardware and/or software deployments and can be configured in a variety of ways. In many embodiments, the sustainability logic can be configured as a standalone device, exist as a logic in another network device, be distributed among various network devices operating in tandem, or remotely operated as part of a cloud-based network management tool. In further embodiments, one or more servers 810 can be configured with or otherwise operate the sustainability logic. In many embodiments, the sustainability logic may operate on one or more servers 810 connected to a communication network 820. The communication network 820 can include wired networks or wireless networks. The sustainability logic can be provided as a cloud-based service that can service remote networks, such as, but not limited to a deployed network 840. In many embodiments, the sustainability logic can be a logic that optimizes the energy consumption of the network 800.

However, in additional embodiments, the sustainability logic may be operated as a distributed logic across multiple network devices. In the embodiment depicted in FIG. 8, a plurality of network access points (APs) 850 can operate as the sustainability logic in a distributed manner or may have one specific device operate as the sustainability logic for all of the neighboring or sibling APs 850. The APs 850 facilitate Wi-Fi connections for various electronic devices, such as but not limited to mobile computing devices including laptop computers 870, cellular phones 860, portable tablet computers 880 and wearable computing devices 890.

In further embodiments, the sustainability logic may be integrated within another network device. In the embodiment depicted in FIG. 8, a wireless LAN controller (WLC 830) may have a sustainability logic that the WLC 830 can use to optimize the energy consumption of the various APs 835 that the WLC 830 is connected to, either wired or wirelessly. In still more embodiments, a personal computer 825 may be utilized to access and/or manage various aspects of the sustainability logic, either remotely or within the network itself. In the embodiment depicted in FIG. 8, the personal computer 825 communicates over the communication network 820 and can access the sustainability logic of the servers 810, or the network APs 850, or the WLC 830.

Although a specific embodiment for various embodiments that a sustainability logic may operate suitable for carrying out the various steps, processes, methods, and operations described herein is discussed with respect to FIG. 8, any of a variety of systems and/or processes may be utilized in accordance with embodiments of the disclosure. For example, the sustainability logic can be configured to execute or otherwise make various network-based decisions in response to one or more standardized power usage charts. This may include, but is not limited to, routing data to devices that are more energy efficient, etc. The aspects described in FIG. 8 may also be interchangeable with other elements of FIGS. 1–7 and 9–18 as required to realize a particularly desired embodiment.

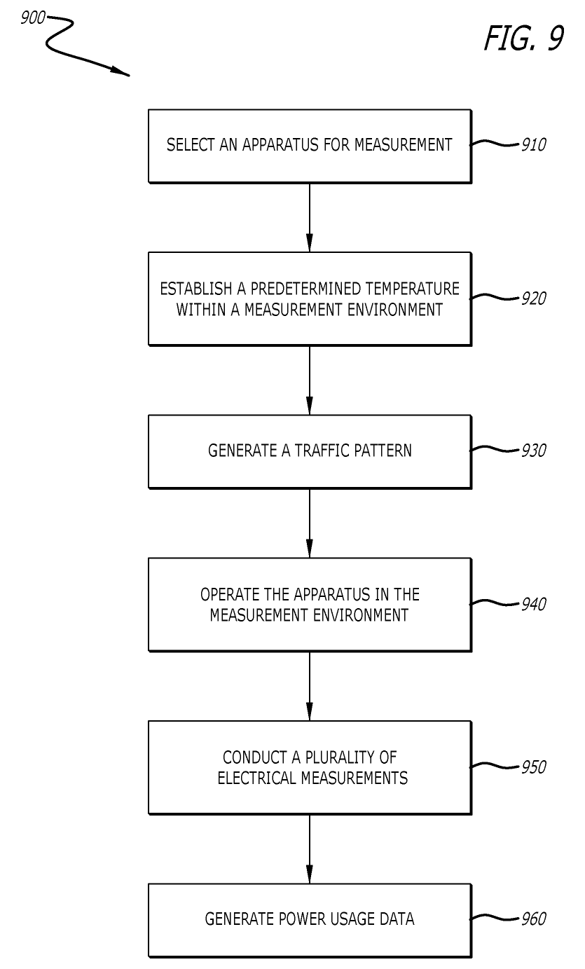

Referring to FIG. 9, a flowchart depicting a process 900 for generating standardized power usage data, in accordance with various embodiments of the disclosure is shown. In many embodiments, the process 900 can select an apparatus for measurement (block 910). The apparatus may be a device, such as a network device like a server, switch, access point, router, or the like. In certain embodiments, the apparatus can be a component within a device, such as a power supply.

In a number of embodiments, the process 900 can establish a predetermined temperature within a measurement environment (block 920). A measurement environment can be configured within a testing chamber or other area that can have a regulated and/or known stable temperature. In some embodiments, this may be a specialized testing device that has an enclosed space with a thermostat that can regulate the interior during testing to various temperatures.

In more embodiments, the process 900 can generate a traffic pattern (block 930). As discussed above, traffic patterns can be configured to mimic various daily usage patterns such as the internet, data center, or other location. The traffic patterns may vary and can be somewhat randomly generated such that the randomness is contained to within a certain predetermined range.

In additional embodiments, the process 900 can operate the apparatus in the measurement environment (block 940). In various embodiments, the measurement environment can be a testing chamber that is configured to provide a power supply with various regulated or normalized attributes, and have a data connection to the device such that it may operate within the chamber. In some embodiments, the operation can be done in a room with a stable and known temperature.

In further embodiments, the process 900 can conduct a plurality of electrical measurements (block 950). As discussed above, with respect to FIG. 6, a number of electrical measurements can be made across various temperatures and traffic patterns. Each of the combinations can yield a unique result so taking multiple tests can help to standardize the power usage data between various devices and deployment scenarios.

In still more embodiments, the process 900 can generate power usage data (block 960). The power usage data can be utilized to create one or more standardized power usage charts. The power usage data can include data related to the specific device under testing and may include specific values at a point in time, or can be averaged over a given time window.

Although a specific embodiment for a process for generating standardized power usage data suitable for carrying out the various steps, processes, methods, and operations described herein is discussed with respect to FIG. 9, any of a variety of systems and/or processes may be utilized in accordance with embodiments of the disclosure. For example, measuring environment can be equipped with a normalize or other standardized electrical connection such that a better understanding of the power used can be known. The aspects described in FIG. 9 may also be interchangeable with other elements of FIGS. 1–8 and FIGS. 10–18 as required to realize a particularly desired embodiment.

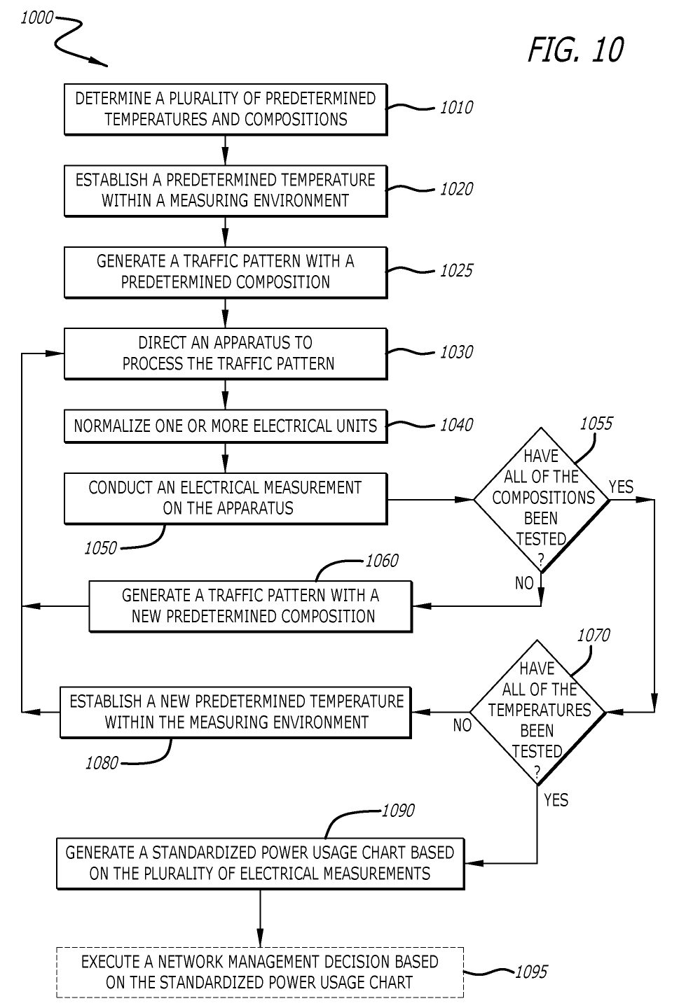

Referring to FIG. 10, a flowchart depicting a process 1000 for generating standardized power usage charts, in accordance with various embodiments of the disclosure is shown. In many embodiments, the process 1000 can determine a plurality of predetermined temperature and compositions (block 1010). To generate a standardized power usage chart, a number of different temperatures and traffic patterns need to be included. The exact mix of these may vary from device to device or component to component.

In a number of embodiments, the process 1000 can establish a predetermined temperature within a measuring environment (block 1020). As described above, a measurement environment can be configured within a testing chamber or other area that can have a regulated and/or known stable temperature. In some embodiments, this may be a specialized testing device that has an enclosed space with a thermostat that can regulate the interior during testing to various temperatures.

In more embodiments, the process 1000 can generate a traffic pattern with a predetermined composition (block 1025). The composition of a traffic pattern can be fixed or at least limited to certain types of data streams. For example, traffic patterns can be configured to mimic various daily usage patterns such as the internet, data center, or other location. The traffic patterns may vary and can be somewhat randomly generated such that the randomness is contained to within a certain predetermined range.

In additional embodiments, the process 1000 can direct an apparatus to process the traffic pattern (block 1030). Typically, this is done through some sort of communicative coupled connection, such as, but not limited to, a network connection. In some embodiments, an ethernet or other wired local area network connection is utilized. However, for certain embodiments, a wireless connection may be desired either in place of or in tandem with a wired connection.

In further embodiments, the process 1000 can normalize one or more electrical units (block 1040). The electrical units can be selected based on the type of power supply being utilized. However, the type of device and/or component being tested may also direct which electrical attributes should be normalized or otherwise standardized across various tests. This can help show the true power used during normal operation.

In still more embodiments, the process 1000 can conduct an electrical measurement on the apparatus (block 1050). The electrical measurement can be configured to occur over a series of instant points in time, or may be done over a time window that is averaged out or otherwise valued at a maximum or minimum value, etc. The length of the tests can vary based on these variables.

Subsequently, the process 1000 can determine if all of the compositions have been tested (block 1055). If it is determined that one or more compositions are still left to be tested, the process 1000 can generate a traffic pattern with a new predetermined composition (block 1060). This new predetermined composition can then be processed by the apparatus (block 1030).

However, if it is determined that all compositions have been tested, the process 1000 can subsequently determine if all of the temperature ranges have been tested (block 1070). If there are one or more temperature ranges that are required to be tested, the process 1000 can establish a new predetermined temperature within the measuring environment (block 1080). This can begin a new set of reconfigurations and testing of various compositions of traffic patterns for that temperature setting.

However, if all of the temperature ranges have been tested, then the process 1000 can generate a standardized power usage chart based on the plurality of electrical measurements (block 1090). The standardized power usage chart can be configured to match previously released standardized power usage charts. In some embodiments, the standardized power usage chart may be stored as data and utilized for various decision-making operations.

Finally, in certain optional embodiments, the process 1000 can execute a network management decision based on the standardized power usage chart (block 1095). In response to the standardized power usage chart data, the process 1000 can determine that one or more data packets should be routed to a different location. In some embodiments, the process 1000 can determine one or more network devices to shut down or put in a lower-power state based on the available standardized power usage charts.

Although a specific embodiment for a process for generating standardized power usage charts suitable for carrying out the various steps, processes, methods, and operations described herein is discussed with respect to FIG. 10, any of a variety of systems and/or processes may be utilized in accordance with embodiments of the disclosure. For example, the order of the processing herein can vary based on the application desired. The aspects described in FIG. 10 may also be interchangeable with other elements of FIGS. 1–9 and FIGS. 11–18 as required to realize a particularly desired embodiment.

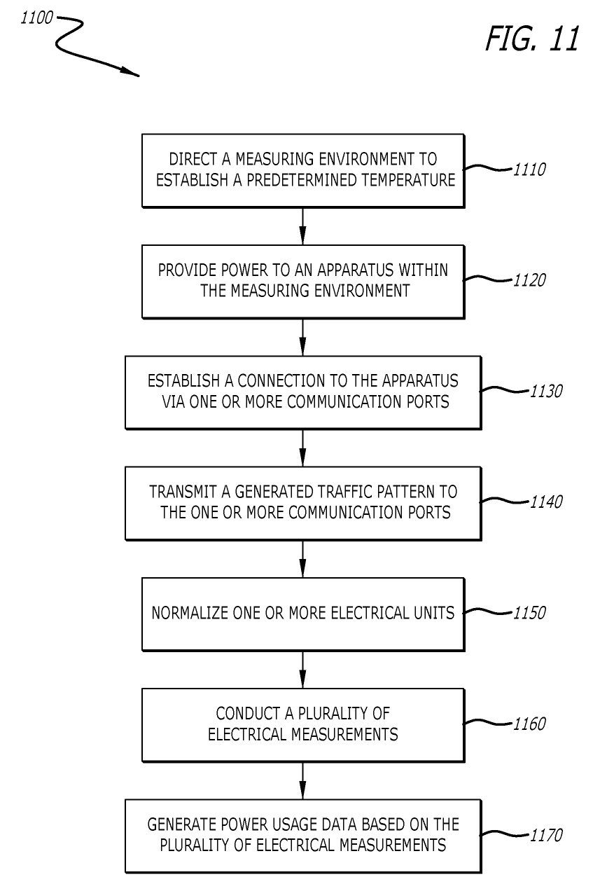

Referring to FIG. 11, a flowchart depicting a process 1100 for conducting measurements to generate standardized power usage data, in accordance with various embodiments of the disclosure is shown. In many embodiments, the process 1100 can direct a measuring environment to establish a predetermined temperature (block 1110). A measuring environment may typically have a known/stable temperature that can be regulated through a thermostat or other control system. The process 1100 may either have direct access over that control system, or can direct or otherwise transmit a signal to a control system to apply a certain testing temperature.

In a number of embodiments, the process 1100 can provide power to an apparatus within the measuring environment (block 1120). In some embodiments, the measuring environment is a testing chamber. Within such a chamber, a power supply may be provided that can be utilized by an apparatus that is to undergo testing.

In more embodiments, the process 1100 can establish a connection to the apparatus via one or more communication ports (block 1130). In certain embodiments, the measuring environment can be configured with one or more wired connections, such as, but not limited to, an ethernet connection, or other wired and/or wireless connection.

In additional embodiments, the process 1100 can transmit a generated traffic pattern to the one or more communication ports (block 1140). As described above, a plurality of various traffic patterns can be generated with different use compositions. The traffic pattern can be sent to the apparatus to be tested through one or more communicatively coupled connections.

In still more embodiments, the process 1100 can normalize one or more electrical units (block 1150). The electrical units can be selected based on the type of power supply being utilized. However, the type of device and/or component being tested may also direct which electrical attributes should be normalized or otherwise standardized across various tests. This can help show the true power used during normal operation.

In various embodiments, the process 1100 can conduct a plurality of electrical measurements (block 1160). The electrical measurements can be configured to occur over a series of instant points in time, or may be done over a time window that is averaged out or otherwise valued at a maximum or minimum value, etc. The length of the tests can vary based on these variables.

In further embodiments, the process 1100 can generate power usage data based on the plurality of electrical measurements (block 1170). The power usage data can be utilized to create one or more standardized power usage charts. The power usage data can include data related to the specific device under testing and may include specific values at a point in time, or can be averaged over a given time window.

Although a specific embodiment for a process for conducting measurements to generate standardized power usage data suitable for carrying out the various steps, processes, methods, and operations described herein is discussed with respect to FIG. 11, any of a variety of systems and/or processes may be utilized in accordance with embodiments of the disclosure. The aspects described in FIG. 11 may also be interchangeable with other elements of FIGS. 1–10 and FIG. 11 as required to realize a particularly desired embodiment.

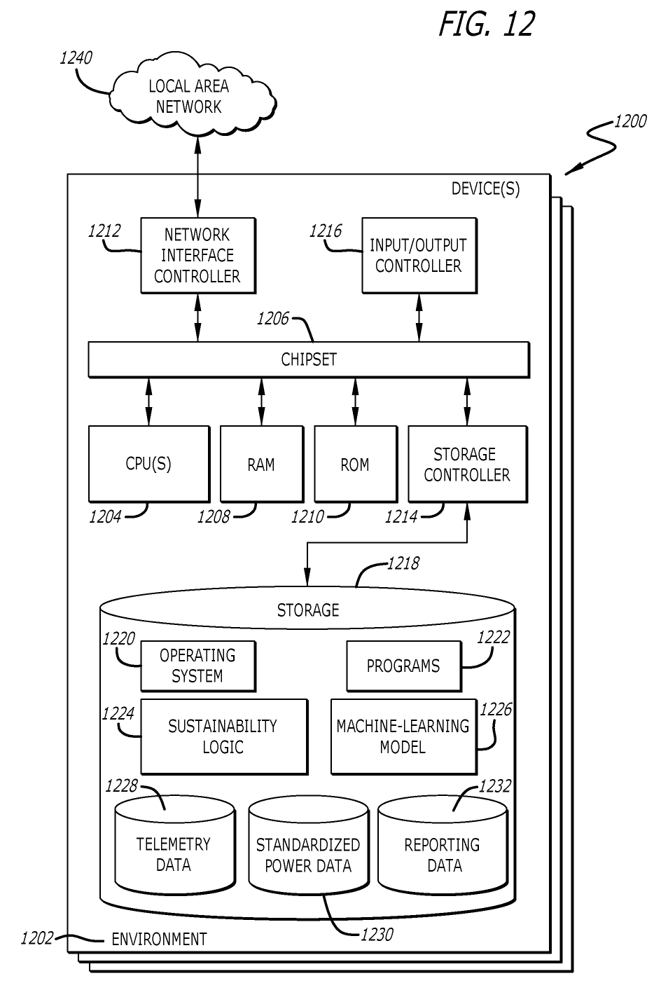

Referring to FIG. 12, a conceptual block diagram of a device 1200 suitable for configuration with a sustainability logic, in accordance with various embodiments of the disclosure is shown. The embodiment of the conceptual block diagram depicted in FIG. 12 can illustrate a conventional server, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 12 can also illustrate an access point, a switch, or a router in accordance with various embodiments of the disclosure. The device 1200 may, in many non-limiting examples, correspond to physical devices or to virtual resources described herein.

In many embodiments, the device 1200 may include an environment 1202 such as a baseboard or “motherboard,” in physical embodiments that can be configured as a printed circuit board with a multitude of components or devices connected by way of a system bus or other electrical communication paths. Conceptually, in virtualized embodiments, the environment 1202 may be a virtual environment that encompasses and executes the remaining components and resources of the device 1200. In more embodiments, one or more processors 1204, such as, but not limited to, central processing units (“CPUs”) can be configured to operate in conjunction with a chipset 1206. The processor(s) 1204 can be standard programmable CPUs that perform arithmetic and logical operations necessary for the operation of the device 1200.

In a number of embodiments, the processor(s) 1204 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 1206 may provide an interface between the processor(s) 1204 and the remainder of the components and devices within the environment 1202. The chipset 1206 can provide an interface to a random-access memory (RAM 1208), which can be used as the main memory in the device 1200 in some embodiments. The chipset 1206 can further be configured to provide an interface to a computer-readable storage medium such as a read-only memory (ROM 1210) or non-volatile RAM (NVRAM) for storing basic routines that can help with various tasks such as, but not limited to, starting up the device 1200 and/or transferring information between the various components and devices. The ROM 1210 or NVRAM can also store other application components necessary for the operation of the device 1200 in accordance with various embodiments described herein.

Additional embodiments of the device 1200 can be configured to operate in a networked environment using logical connections to remote computing devices and computer systems through a network, such as the network 1240. The chipset 1206 can include functionality for providing network connectivity through a network interface card (NIC 1212), which may comprise a gigabit Ethernet adapter or similar component. The NIC 1212 can be capable of connecting the device 1200 to other devices over the network 1240. It is contemplated that multiple NICs 1212 may be present in the device 1200, connecting the device to other types of networks and remote systems.

In further embodiments, the device 1200 can be connected to a storage 1218 that provides non-volatile storage for data accessible by the device 1200. The storage 1218 can, for instance, store an operating system 1220, applications 1222, telemetry data 1228, standardized power data 1230, and reporting data 1232, which are described in greater detail below. The storage 1218 can be connected to the environment 1202 through a storage controller 1214 connected to the chipset 1206. In certain embodiments, the storage 1218 can consist of one or more physical storage units. The storage controller 1214 can interface with the physical storage units through a serial attached SCSI (SAS) interface, a serial advanced technology attachment (SATA) interface, a fiber channel (FC) interface, or other type of interface for physically connecting and transferring data between computers and physical storage units. The telemetry data 1228 may include one or more descriptions about the configuration or actions of the network. The standardized power data 1230 can include one or more configurations on how various tests are supposed to be conducted. The reporting data 1232 may include information about power usage or other testing results that are to be reported out.

The device 1200 can store data within the storage 1218 by transforming the physical state of the physical storage units to reflect the information being stored. The specific transformation of physical state can depend on various factors. Examples of such factors can include, but are not limited to, the technology used to implement the physical storage units, whether the storage 1218 is characterized as primary or secondary storage, and the like.

In many more embodiments, the device 1200 can store information within the storage 1218 by issuing instructions through the storage controller 1214 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1200 can further read or access information from the storage 1218 by detecting the physical states or characteristics of one or more particular locations within the physical storage units.

In addition to the storage 1218 described above, the device 1200 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1200. In some examples, the operations performed by a cloud computing network, and or any components included therein, may be supported by one or more devices similar to device 1200. Stated otherwise, some or all of the operations performed by the cloud computing network, and or any components included therein, may be performed by one or more devices 1200 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1218 can store an operating system 1220 utilized to control the operation of the device 1200. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 1218 can store other system or application programs and data utilized by the device 1200.

In many additional embodiments, the storage 1218 or other computer-readable storage media is encoded with computer-executable instructions which, when loaded into the device 1200, may transform it from a general-purpose computing system into a special-purpose computer capable of implementing the embodiments described herein. These computer-executable instructions may be stored as application 1222 and transform the device 1200 by specifying how the processor(s) 1204 can transition between states, as described above. In some embodiments, the device 1200 has access to computer-readable storage media storing computer-executable instructions which, when executed by the device 1200, perform the various processes described above with regard to FIGS. 1–11. In certain embodiments, the device 1200 can also include computer-readable storage media having instructions stored thereupon for performing any of the other computer-implemented operations described herein.

In many further embodiments, the device 1200 may include a sustainability logic 1224. The sustainability logic 1224 can be configured to perform one or more of the various steps, processes, operations, and/or other methods that are described above. Often, the sustainability logic 1224 can be a set of instructions stored within a non-volatile memory that, when executed by the controller(s)/processor(s) 1204 can carry out these steps, etc. In some embodiments, the sustainability logic 1224 may be a client application that resides on a network-connected device, such as, but not limited to, a server, switch, personal or mobile computing device in a single or distributed arrangement. In certain embodiments, the sustainability logic 1224 reduces the energy consumption of the network by creating and managing one or more energy management groups in the network.

In still further embodiments, the device 1200 can also include one or more input/output controllers 1216 for receiving and processing input from a number of input devices, such as a keyboard, a mouse, a touchpad, a touch screen, an electronic stylus, or other type of input device. Similarly, an input/output controller 1216 can be configured to provide output to a display, such as a computer monitor, a flat panel display, a digital projector, a printer, or other type of output device. Those skilled in the art will recognize that the device 1200 might not include all of the components shown in FIG. 12 and can include other components that are not explicitly shown in FIG. 12 or might utilize an architecture completely different than that shown in FIG. 12.

As described above, the device 1200 may support a virtualization layer, such as one or more virtual resources executing on the device 1200. In some examples, the virtualization layer may be supported by a hypervisor that provides one or more virtual machines running on the device 1200 to perform functions described herein. The virtualization layer may generally support a virtual resource that performs at least a portion of the techniques described herein.

Finally, in numerous additional embodiments, data may be processed into a format usable by a machine-learning model 1226 (e.g., feature vectors), and or other pre-processing techniques. The machine-learning (“ML”) model 1226 may be any type of ML model, such as supervised models, reinforcement models, and/or unsupervised models. The ML model 1226 may include one or more of linear regression models, logistic regression models, decision trees, Naïve Bayes models, neural networks, k-means cluster models, random forest models, and/or other types of ML models 1226.

The ML model(s) 1226 can be configured to generate inferences to make predictions or draw conclusions from data. An inference can be considered the output of a process of applying a model to new data. This can occur by learning from at least the telemetry data 1228, the standardized power data 1230, and the reporting data 1232, and use that learning to predict future outcomes. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 1226 may be generated by human/administrator verifications or may compare predicted outcomes with actual outcomes.

Although a specific embodiment for a device suitable for configuration with a sustainability logic for carrying out the various steps, processes, methods, and operations described herein is discussed with respect to FIG. 12, any of a variety of systems and/or processes may be utilized in accordance with embodiments of the disclosure. For example, the device 1200 may be in a virtual environment such as a cloud-based network administration suite, or it may be distributed across a variety of network devices or switches. The elements depicted in FIG. 12 may also be interchangeable with other elements of FIGS. 1–11 and 13–18 as required to realize a particularly desired embodiment.

In response to the limitations identified in traditional network power measurement, the embodiments described herein provide a comprehensive solution for generating high-fidelity, modular energy metrics. Conventional reporting methods often rely on coarse software estimates that fail to account for the dynamic impact of environmental stressors or the specific energy draw of individual radio components. By establishing a standardized environment for characterization, the present disclosure allows for the creation of a granular library of modular data points. This modular approach enables the system to move beyond simple estimation and toward precise, repeatable modeling of energy consumption across complex hardware ecosystems.

Various embodiments of this disclosure attempt to solve the problem of power measurement inaccuracy by utilizing a specialized characterization methodology. The system isolates individual hardware elements, such as discrete radios within a wireless access point, and subjects them to controlled traffic loads and thermal variations. This process generates a standardized power-versus-temperature table that serves as a foundational building block for larger system simulations. By capturing these modular characterizations, the disclosure ensures that the total power footprint of a device can be mathematically reconstructed with a level of accuracy that was previously unattainable in field environments.

The embodiments further address the need for scalability by normalizing power data across heterogeneous platforms. In modern data centers, networking infrastructure often operates alongside advanced compute and storage resources, each with its own disparate power reporting standard. The systems described herein utilize real-time telemetry interfaces to override inaccurate software-reported values with high-fidelity measurements from the physical layer. This allows a central sustainability logic to bridge the gap between compute and network layers, consolidating all telemetry into a single, unified sustainability metric for the entire organization.

To bridge the gap between laboratory data and real-world deployment, the disclosure incorporates a predictive simulation engine. This engine applies the characterized modular units to a projected network topology, modeling the cumulative power sum of multi-hop signal paths and wireless backhaul interactions. The simulation accounts for dynamic variables such as signal attenuation and user demand patterns to predict how energy will be consumed in a specific customer environment. This capability allows administrators to evaluate the sustainability impact of various designs before a single piece of hardware is physically installed or configured.

Ultimately, embodiments described herein attempt to facilitate automated, net-zero-aligned architectural changes through a multifactor optimization engine. By processing real-time telemetry against business and environmental needs, the system can identify specific hardware upgrades or topology modifications required to meet a predetermined sustainability target. The optimization engine calculates a maximum return on energy and carbon dioxide savings, providing a clear roadmap for reducing a network's total carbon footprint. This transition from static reporting to active, data-driven optimization empowers organizations to achieve their environmental goals while maintaining high levels of network performance.

Those skilled in the art will recognize that a customer install base can be understood as the total collection of hardware and software resources currently deployed and operational within a specific organization or network environment. This includes all networking devices, compute servers, storage arrays, and client endpoints that are actively managed to provide digital services and connectivity. In the context of sustainability, the customer install base can serve as the foundational baseline against which all energy efficiency improvements and carbon footprint reductions are measured. By accurately identifying every component within this base, the system can begin to model the current energy consumption profile of the entire ecosystem.

In various embodiments, the customer install base is not merely a static list of equipment but a dynamic representation of an organization's digital infrastructure. It may include legacy hardware with relatively high power draw alongside modern, energy-efficient units, creating a complex and heterogeneous environment for power modeling. The sustainability logic may interact with the customer install base to pull real-time telemetry and usage patterns, allowing for a highly granular analysis of how data traffic impacts energy consumption. Understanding the composition and behavior of this base is essential for identifying which architectural changes will yield the highest return on energy and the most significant progress toward a net-zero emissions target.

Often a library of modular component characterizations can be understood as a standardized digital repository containing high-fidelity electrical profiles for individual hardware elements. This library is created by testing discrete components, such as a specific model of a wireless radio or a network processor, under a wide variety of controlled environmental and traffic conditions. Each entry in the library provides a detailed mapping of how that specific component consumes power in response to variables like temperature, data throughput, and packet composition. By breaking a complex system down into these modular building blocks, the system can mathematically reconstruct the power profile of any device configuration with extreme precision.

In many embodiments, the library of modular component characterizations acts as the primary data source for predictive simulations and multifactor optimization engines. Instead of relying on general manufacturer estimates, the library provides standardized power-vs-temperature tables that reflect the actual physical behavior of the hardware at the component level. This allows the system to simulate the energy impact of a proposed network design without needing to physically test the hardware in a laboratory setting every time a change is made. The library is often synchronized with cloud-based network simulators to ensure that as new hardware is characterized, the most up-to-date modular data is available for modeling customer deployments across the globe.

Those skilled in the art will recognize that a cumulative power sum can be understood as the total calculated energy consumption for a specific data path or network topology over a defined period. This metric is arrived at by aggregating the individual power contributions of every piece of hardware that a specific signal or data packet must touch as it moves from its source to its destination. For a multi-hop wireless link, the cumulative power sum would include the energy consumed by the entry gateway, every intervening network switch, and each access point along the path, including the specific overhead for the radios used in the transmission. This comprehensive calculation provides a much more accurate picture of the true energy cost of a network service than measuring individual devices in isolation.

In various embodiments, calculating a cumulative power sum involves modeling signal attenuation and user demand patterns as dynamic variables that adjust the power weight of each modular unit. If a signal must travel through multiple physical obstacles or over long distances, the cumulative power sum will increase as the individual radios are forced to operate at higher power levels to maintain connectivity. This metric allows organizations to visualize the environmental impact of their network design and to compare different topologies on an apples-to-apples basis. By understanding the cumulative power sum of their current and future architectures, organizations can make data-driven decisions about which hardware upgrades or design changes will most effectively reduce their total carbon footprint.

Often a return on energy metric can be understood as a performance value that measures the efficiency of a network or compute resource by comparing the work performed to the energy consumed. This metric is frequently expressed in terms of data throughput per watt, such as gigabits per second per watt, or in terms of carbon emissions per unit of data processed. By calculating the return on energy, a sustainability logic can identify which parts of a network are providing the most value for the energy they use and which parts are operating inefficiently. This allows administrators to prioritize architectural changes that maximize the utility of every kilowatt-hour consumed by the organization.

In many embodiments, the return on energy metric is processed via a multifactor optimization engine to identify the most cost-effective path toward a predetermined sustainability target. The engine may analyze the return on energy alongside other critical business factors such as hardware cost, physical space utilization, and the impact of the hardware on localized cooling and HVAC systems. By optimizing for a high return on energy, the system ensures that sustainability goals are met without sacrificing the performance or reliability required by the organization's business needs. This metric serves as a key performance indicator for the success of sustainability initiatives, providing a clear and measurable way to report progress toward net-zero emissions and energy efficiency goals.

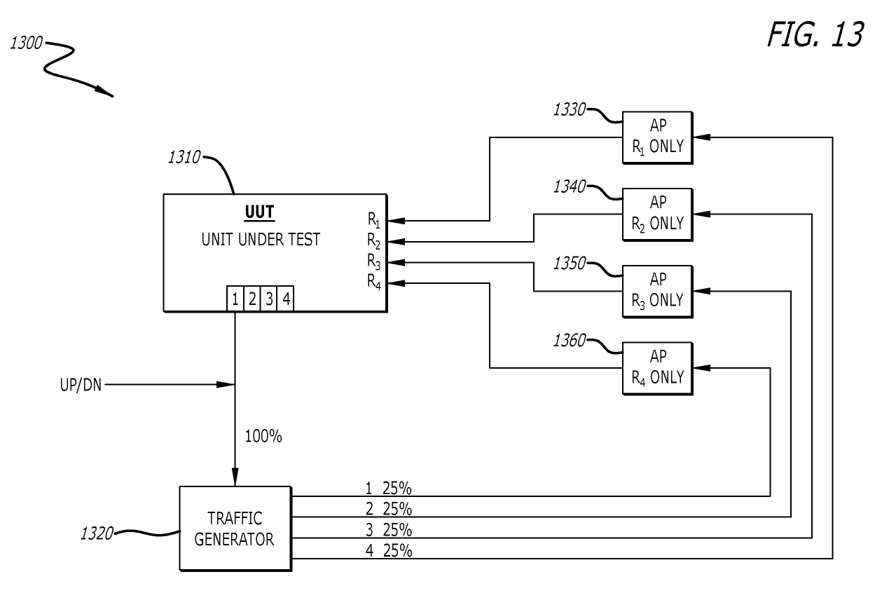

The disclosure includes FIGS. 13–18 to provide technical context for several advanced sustainability features that were not addressed in the parent application. Specifically, these figures illustrate the transition from a hardware-centric measurement system to a modular, predictive simulation ecosystem capable of modeling complex network topologies. While earlier embodiments discuss the physical apparatus for thermal testing, the following embodiments add context for characterizing individual modular radio units to create a library of fractional power scaling data. Furthermore, the introduction of heterogeneous platform integration can explain how embodiments may normalize power data across compute and networking layers, which is critical for meeting predetermined sustainability targets in mixed hardware environments. These embodiments also include automated logic flows for a multifactor optimization engine that identifies required architectural changes, solving the problem of manual carbon footprint estimation in multi-hop signal paths.

Referring to FIG. 13, a modular radio characterization test setup for isolating individual component power impacts in accordance with various embodiments of the disclosure is shown. The modular radio characterization test setup 1300 can be configured to establish a standardized baseline for power consumption by characterizing the electrical behavior of discrete hardware components under controlled load conditions. In many embodiments, the modular radio characterization test setup 1300 can utilize a mathematical characterization process to generate modular power data that can be subsequently used in predictive simulation environments. This configuration can allow a system to model the total power consumption of complex network topologies without requiring physical testing of every possible hardware combination. Certain embodiments of the modular radio characterization test setup 1300 can be specifically tailored to analyze the impact of individual radios in wireless access points to support granular sustainability reporting and carbon footprint calculations.

In many embodiments, the modular radio characterization test setup 1300 can include a unit under test 1310 that comprises the hardware being characterized for power efficiency. The unit under test 1310 can be a network device such as a wireless access point, a router, or a specialized compute node containing a plurality of modular radios. As depicted in FIG. 13, the unit under test 1310 can be configured with a first radio R1, a second radio R2, a third radio R3, and a fourth radio R4 which are each capable of independent data transmission and reception. The unit under test 1310 can also include a primary interface such as an RJ45 port for receiving aggregate traffic loads that are then distributed to the internal radios. In various embodiments, the unit under test 1310 can be operated in a testing mode that allows for the precise measurement of real and apparent power draw as data is processed through its internal circuitry.

In some embodiments, the modular radio characterization test setup 1300 can comprise a traffic generator 1320 which serves as the primary source of controlled data patterns during a characterization process. The traffic generator 1320 can be configured to provide a 100% aggregate traffic load to the unit under test 1310 to simulate maximum capacity operations. Additionally, the traffic generator 1320 can include one or more control channels that provide fractional traffic loads to the peripheral components of the modular radio characterization test setup 1300. For example, the traffic generator 1320 might provide individual 25% traffic splits to various monitoring nodes to ensure a standardized load is maintained across all active radio paths. In many embodiments, the traffic generator 1320 can be configured to generate packets of varying sizes and types, such as internet mix traffic or random data, to evaluate how different packet compositions affect the power usage of the unit under test 1310.

In additional embodiments, the modular radio characterization test setup 1300 can include a first characterization access point 1330 that is configured to interact exclusively with the first radio R1 of the unit under test 1310. The first characterization access point 1330 can receive a 25% traffic load from the traffic generator 1320 and facilitate a discrete communication path with the unit under test 1310. By isolating the first radio R1, the first characterization access point 1330 can assist in determining the specific power draw associated with only one active radio set. This isolation can allow the modular radio characterization test setup 1300 to capture the individual radio impact as a modular data point for later use in a simulation library. In certain embodiments, the first characterization access point 1330 can be located within a controlled environment to minimize external radio frequency interference during the measurement.

In various embodiments, the modular radio characterization test setup 1300 can include a second characterization access point 1340 that is configured to interact exclusively with the second radio R2 of the unit under test 1310. The second characterization access point 1340 can receive a dedicated traffic split from the traffic generator 1320 to maintain a standardized load on the second radio R2. This configuration can allow the system to compare the power efficiency of the second radio R2 against other radios within the same unit under test 1310. The second characterization access point 1340 can also be utilized to verify the linear or non-linear scaling of power when multiple radios are operating simultaneously. In some embodiments, the second characterization access point 1340 can provide real-time telemetry back to a central controller to ensure the wireless link remains stable throughout the characterization cycle.

In further embodiments, the modular radio characterization test setup 1300 can include a third characterization access point 1350 that is configured to interact exclusively with the third radio R3 of the unit under test 1310. The third characterization access point 1350 can be configured to handle specialized packet types or specific traffic rates to evaluate the third radio R3 under different operating conditions. By using the third characterization access point 1350 as a dedicated listener, the modular radio characterization test setup 1300 can ensure that the data processed by the third radio R3 does not bleed into the measurement of other modular components. This high degree of isolation can be necessary for accurately modeling complex multi-band wireless devices. In many embodiments, the third characterization access point 1350 can be connected to the system via a high-speed wired backbone to ensure that the testing bottleneck is always the wireless interface being characterized.

In still more embodiments, the modular radio characterization test setup 1300 can include a fourth characterization access point 1360 that is configured to interact exclusively with the fourth radio R4 of the unit under test 1310. The fourth characterization access point 1360 can serve as a modular endpoint for a backhaul radio path, which is often used in mesh or repeater mode topologies. This specific configuration can allow the modular radio characterization test setup 1300 to characterize the power cost of maintaining a wireless backbone link as opposed to a client-facing link. The fourth characterization access point 1360 can be operated at various signal attenuation levels to simulate different physical distances or obstacles in a virtual topology. In certain embodiments, the fourth characterization access point 1360 can be powered by a standardized one-hundred twenty volt power brick to maintain a consistent electrical baseline for the characterization.

In a non-limiting example of the operation of the modular radio characterization test setup 1300, the traffic generator 1320 can initiate a test cycle by sending a 100% aggregate traffic load to the RJ45 port of the unit under test 1310. The unit under test 1310 can then distribute this load equally across its first radio R1, second radio R2, third radio R3, and fourth radio R4, with each radio processing a 25% share of the data. Simultaneously, the traffic generator 1320 can provide synchronized 25% traffic splits to the first characterization access point 1330, the second characterization access point 1340, the third characterization access point 1350, and the fourth characterization access point 1360. This creates four isolated wireless paths that allow the system to measure the cumulative power sum and individual component contributions in real-time. By comparing the total power draw to the sum of the isolated parts, the system can identify any non-linear power losses occurring within the internal circuitry of the unit under test 1310.

In another example embodiment, the modular radio characterization test setup 1300 can be configured to model a mesh network situation by designating the fourth radio R4 of the unit under test 1310 as a backhaul radio. In this embodiment, the traffic generator 1320 can configure the fourth characterization access point 1360 to simulate a high-bandwidth link between infrastructure nodes. The system can then measure the power draw of the unit under test 1310 as it balances the client traffic from the first characterization access point 1330 with the backhaul traffic from the fourth characterization access point 1360. This configuration can allow the modular radio characterization test setup 1300 to generate a specific modular data point for mesh-mode power consumption. Such a data point can be critical for a sustainability simulator when determining whether a wireless mesh or a wired switch backbone is more energy efficient for a particular customer deployment. The power data generated from this mesh network configuration is used to perform mesh-node power calculations, which determine the incremental energy cost of. maintaining a wireless backhaul link compared to a client-facing link, and which may be stored as a distinct modular data point within the library of modular component characterizations.

In yet another example, the modular radio characterization test setup 1300 can be utilized to evaluate the impact of upstream and downstream traffic distributions on component-level power usage. The traffic generator 1320 can be configured to send a traffic pattern consisting of 20% upstream data and 80% downstream data to the unit under test 1310 via its ethernet port. The first characterization access point 1330 and the second characterization access point 1340 can then act as data sinks to measure how the individual radios handle this unbalanced load. The resulting power data can be captured and stored in a library of modular component characterizations to facilitate more accurate predictive modeling. This high-fidelity data can ultimately be used to identify architectural changes in a network that can reduce the carbon footprint of an entire organization by optimizing the use of individual radios.

Although a specific embodiment for a modular radio characterization test setup 1300 for carrying out the various steps, processes, methods, and operations described herein is discussed with respect to FIG. 13, any of a variety of systems and/or devices may be utilized in accordance with embodiments of the disclosure. For example, a specialized power analyzer could be integrated into the test setup to capture high-frequency transients in the power draw of the unit under test. The elements depicted in FIG. 13 may also be interchangeable with other elements of FIGS. 1–12 and FIGS. 14–18 as required to realize a particularly desired embodiment.

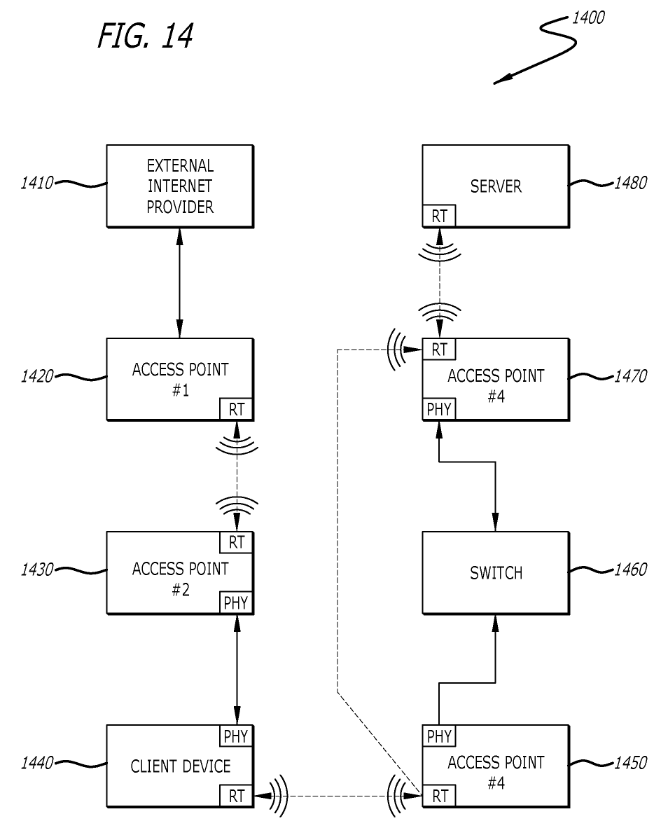

Referring to FIG. 14, a schematic diagram illustrating a network topology and signal path for predictive power modeling in accordance with various embodiments of the disclosure is shown. The network topology 1400 can be configured to simulate real world deployment scenarios for calculating a cumulative power sum across a distributed hardware ecosystem. In many embodiments, the network topology 1400 can represent a customer install base and can be utilized to evaluate the impact of architectural changes on energy efficiency. This visual representation can allow a sustainability logic to model signal paths and attenuation between various infrastructure nodes and client devices. Certain embodiments of the network topology 1400 can be used to identify specific bottlenecks in a network where energy consumption might be optimized to meet a predetermined sustainability target.

In many embodiments, the network topology 1400 can include an external internet provider 1410 that serves as the primary data source for the simulated environment . The external internet provider 1410 can represent a third party service such as Xfinity or another high speed data uplink that feeds traffic into a local network. In various embodiments, the external internet provider 1410 can be modeled with specific bandwidth and latency characteristics to simulate different service tiers. The external internet provider 1410 can be communicatively coupled to an entry point infrastructure device to initiate a data path through the network topology 1400. In certain embodiments, the external internet provider 1410 can provide a 100% aggregate traffic load that is then processed and distributed by the internal components of the system.

In some embodiments, the network topology 1400 can comprise a first access point 1420 that is configured to act as a gateway for traffic received from the external internet provider 1410 . The first access point 1420 can include a real time telemetry interface RT used to capture high fidelity power consumption data during the modeling process. In many embodiments, the first access point 1420 can broadcast wireless signals to downstream devices to establish a connectivity layer within the ecosystem. The first access point 1420 can be modeled with specific radio configurations to determine its individual power impact based on aggregate traffic loads. In various embodiments, the first access point 1420 can serve as a primary bridge between the external internet provider 1410 and the internal network switch architecture.

In additional embodiments, the network topology 1400 can include a second access point 1430 that is configured to route traffic between infrastructure nodes and endpoint devices. The second access point 1430 can include a physical layer interface PHY and a real time telemetry interface RT to support both wired and wireless communication paths. In many embodiments, the second access point 1430 can be utilized to model the power cost of a single hop within the network distribution layer. The second access point 1430 can receive data from a central controller and distribute it to mobile clients within its broadcast range. In certain embodiments, the second access point 1430 can be configured to operate in a low power state when no active clients are detected to optimize the overall energy footprint of the network topology 1400.

In various embodiments, the network topology 1400 can include a client device 1440 that represents an endpoint such as a laptop or a mobile computing device . The client device 1440 can include a physical layer interface PHY and a real time telemetry interface RT to communicate with the second access point 1430. In many embodiments, the client device 1440 can be used to simulate user demand and traffic patterns that trigger radio activity in the upstream access points. The client device 1440 can be moved virtually within the network topology 1400 to model how signal attenuation affects the power weighting of modular radio units. In some embodiments, the client device 1440 can report its own energy consumption data to the sustainability logic to provide a comprehensive view of the total system power draw.

In further embodiments, the network topology 1400 can include a third access point 1450 that is configured to support mesh or repeater mode operations . The third access point 1450 can include a physical layer interface PHY and a real time telemetry interface RT to facilitate high speed backhaul communication. In many embodiments, the third access point 1450 can be used to isolate the power impact of a discrete backhaul radio during mesh mode power calculations. The third access point 1450 can interact wirelessly with other infrastructure nodes to extend the reach of the network without requiring additional wired cabling. In certain embodiments, the third access point 1450 can be modeled as part of a redundant path that automatically activates to maintain connectivity during a simulated link failure.

In still more embodiments, the network topology 1400 can include a network switch 1460 that acts as a central distribution hub for the wired portions of the network . The network switch 1460 can be communicatively coupled to a plurality of access points to route data packets based on destination addresses. In many embodiments, the network switch 1460 can be modeled to determine its contribution to the cumulative power sum of the customer install base. The network switch 1460 can support various transmission speeds and protocols to simulate a heterogeneous environment consisting of different hardware generations. In various embodiments, the network switch 1460 can be configured with power management settings such as energy efficient ethernet to evaluate potential savings in the simulated model.

In additional embodiments, the network topology 1400 can include a fourth access point 1470 that can be utilized to model a signal path that terminates at a server. The fourth access point 1470 can include a physical layer interface PHY and a real time telemetry interface RT to provide high fidelity data to the network simulator. In many embodiments, the fourth access point 1470 can be utilized to model a signal path terminates at a server or other static computing asset. The fourth access point 1470 can handle multiple simultaneous client connections and can be modeled with different radio set activities to determine peak power consumption. In certain embodiments, the fourth access point 1470 can be used to establish a baseline for performance in a dense deployment scenario.

In numerous embodiments, the network topology 1400 can include a server 1480 that represents a static compute or storage resource within the ecosystem . The server 1480 can include a real time telemetry interface RT to report its processing and storage power costs directly to the sustainability logic . In many embodiments, the server 1480 can be the target for data traffic originating from the client device 1440 or the external internet provider 1410. The server 1480 can be modeled as a source of internal data loads that do not traverse the external gateway, allowing for the simulation of intranet traffic patterns. In various embodiments, the server 1480 can be used to evaluate how consolidating compute resources can impact the overall energy efficiency of the network topology 1400.

In a non-limiting example of the operation of the network topology 1400, traffic can originate from the external internet provider 1410 and be received by the first access point 1420. The traffic can then be routed through the network switch 1460 to the second access point 1430, which wirelessly transmits the data to the client device 1440. During this process, each component can use its respective real time telemetry interface RT to report high fidelity power data to a simulator logic. The simulator logic can then use this data to calculate a cumulative power sum for the entire multi-hop signal path. By adjusting the traffic load from the external internet provider 1410, the system can determine how the total footprint scales with increased user demand.

In another example embodiment, the network topology 1400 can be used to model a mesh network situation between the third access point 1450 and the fourth access point 1470. Instead of using a wired connection through the network switch 1460, the third access point 1450 can establish a wireless backhaul link with the fourth access point 1470 using a specific radio set. The sustainability logic can then apply a modular component characterization to this wireless link to determine the added power weight compared to a wired connection. This modeling can allow a user to identify if adding a physical cable would be a required architectural change to meet a sustainability target. The resulting return on energy metric can then be presented to a customer to justify the cost of the hardware upgrade.

In yet another example, the network topology 1400 can simulate a situation where the client device 1440 is accessing a large file stored on the server 1480. Data can travel from the server 1480 to the fourth access point 1470, through the network switch 1460, and finally through the second access point 1430 to reach the client device 1440. The sustainability logic can model signal attenuation as a dynamic variable along this path to adjust the power weight of the modular radio units in the second access point 1430 and the fourth access point 1470. If the signal strength is low, the system might identify that the radios must operate at a higher power level to maintain the link. This information can be used to suggest moving the second access point 1430 closer to the client device 1440 to reduce the cumulative power sum.

Although a specific embodiment for a network topology 1400 for carrying out the various steps, processes, methods, and operations described herein is discussed with respect to FIG. 14, any of a variety of systems and/or devices may be utilized in accordance with embodiments of the disclosure. For example, the network switch 1460 might be replaced by a virtualized software defined networking controller. The elements depicted in FIG. 14 may also be interchangeable with other elements of FIGS. 1–13 and FIGS. 15–18 as required to realize a particularly desired embodiment.

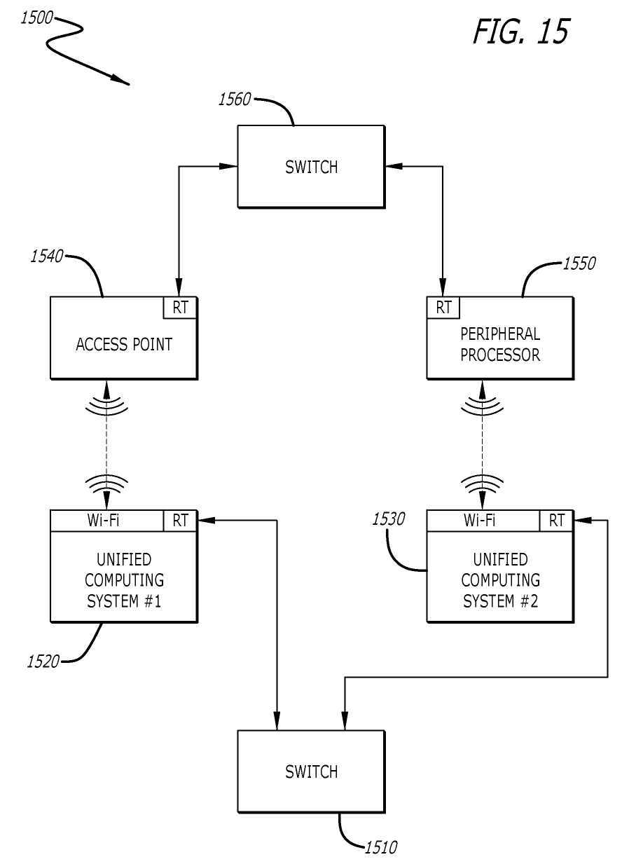

Referring to FIG. 15, a measurement architecture for mixed compute and wireless platforms in accordance with various embodiments of the disclosure is shown. The measurement architecture 1500 can be configured to provide a standardized framework for capturing high fidelity power usage data across a heterogeneous hardware environment. In many embodiments, the measurement architecture 1500 can integrate networking infrastructure with advanced compute resources to model total system efficiency. This configuration can allow a sustainability logic to normalize power data across a compute layer and a network layer into a single unified sustainability metric. Certain embodiments of the measurement architecture 1500 can be utilized to identify energy savings opportunities within a data center or large scale wireless installation.

In many embodiments, the measurement architecture 1500 can include a first switch 1510 that serves as a central connectivity point for the platform. The first switch 1510 can be configured to route data traffic between compute nodes and networking gateways while maintaining a stable communication backbone. In various embodiments, the first switch 1510 can be modeled to determine its contribution to a cumulative power sum of a customer install base. The first switch 1510 can support various wired transmission protocols to facilitate high speed data exchange between diverse hardware platforms. In certain embodiments, the first switch 1510 can be managed via an automated multifactor optimization engine to adjust operating parameters based on real time telemetry.

In some embodiments, the measurement architecture 1500 can comprise a first unified computing system 1520 that represents a first compute resource within the ecosystem. The first unified computing system 1520 can be a hardware node comprising a processor and a plurality of modular radios for wireless communication. In many embodiments, the first unified computing system 1520 can include a first wireless interface Wi-Fi and a first real time telemetry interface RT to support high fidelity data reporting. The first unified computing system 1520 can be configured to process intensive workloads while simultaneously providing wireless connectivity to local clients. In various embodiments, the first unified computing system 1520 can be modeled with specific fractional power scaling data to isolate the energy cost of its compute and radio components.

In additional embodiments, the measurement architecture 1500 can include a second unified computing system 1530 that represents a second compute resource within the environment. The second unified computing system 1530 can include a second wireless interface Wi-Fi and a second real time telemetry interface RT to facilitate standardized power measurements. In many embodiments, the second unified computing system 1530 can be utilized to evaluate load balancing strategies across a distributed compute layer. The second unified computing system 1530 can receive data traffic from a central distribution hub and process it according to a predetermined sustainability target. In certain embodiments, the second unified computing system 1530 can be operated in coordination with other nodes to maximize a return on energy metric for the entire system.

In various embodiments, the measurement architecture 1500 can include an access point 1540 that is configured to provide a wireless gateway to the networking infrastructure. The access point 1540 can include a third real time telemetry interface RT used to report radio set activity and associated power draw. In many embodiments, the access point 1540 can communicate with compute nodes via wireless signal paths to model the impact of air interface interactions. The access point 1540 can be configured with modular radio units that are characterized in a testing chamber to provide accurate predictive data. In some embodiments, the access point 1540 can be a modular component that is interchangeable with other infrastructure nodes to realize a desired architectural change.

In further embodiments, the measurement architecture 1500 can include a peripheral processor 1550 that represents a specialized interface or secondary computing node. The peripheral processor 1550 can include a fourth real time telemetry interface RT to ensure all data processing activity is captured within the unified power model. In many embodiments, the peripheral processor 1550 can be used to handle auxiliary tasks such as environmental monitoring or security protocols. The peripheral processor 1550 can be communicatively coupled to the network infrastructure via wireless links to evaluate the power overhead of secondary telemetry channels. In certain embodiments, the peripheral processor 1550 can be modeled to determine its impact on the cumulative power sum of a projected network topology.

In still more embodiments, the measurement architecture 1500 can include a second switch 1560 that acts as a primary controller for the infrastructure layer. The second switch 1560 can be configured to manage the data flow between the access point 1540 and the peripheral processor 1550. In many embodiments, the second switch 1560 can be utilized to simulate a core network architecture in a large scale enterprise deployment. The second switch 1560 can receive aggregate traffic loads from an external source and distribute them to the downstream modular components. In various embodiments, the second switch 1560 can be monitored to identify potential bottlenecks where high fidelity power data can be used to override software reported power values.

In a non-limiting example of the operation of the measurement architecture 1500, the second switch 1560 can receive a standardized traffic pattern and route it to the access point 1540. The access point 1540 can then wirelessly transmit the data to the first wireless interface Wi-Fi of the first unified computing system 1520. During this transmission, the first real time telemetry interface RT and the third real time telemetry interface RT can provide high fidelity power data to a central sustainability logic. The sustainability logic can then calculate a cumulative power sum for this multi-hop path and normalize the data based on the traffic rate processed. This example demonstrates how the measurement architecture 1500 can be used to model the real world interaction between a network layer and a compute layer.

In another example embodiment, the measurement architecture 1500 can be used to optimize a distributed workload between the first unified computing system 1520 and the second unified computing system 1530. A multifactor optimization engine can analyze the telemetry from the first real time telemetry interface RT and the second real time telemetry interface RT to determine which node is operating at peak efficiency. If the first unified computing system 1520 is determined to have a higher return on energy metric, the first switch 1510 can be directed to route additional traffic to that node. This automated decision making process can identify architectural changes required to meet a net zero emissions target. The resulting optimizations can be reported as part of a standardized power vs temperature table synchronized with a cloud based network simulator.

In yet another example, the measurement architecture 1500 can evaluate the power overhead of auxiliary monitoring by utilizing the peripheral processor 1550. The second switch 1560 can route control plane traffic to the peripheral processor 1550, which wirelessly communicates with the second wireless interface Wi-Fi of the second unified computing system 1530. The fourth real time telemetry interface RT can capture the discrete power impact of this secondary communication channel. By comparing this data to a library of modular component characterizations, the system can determine if the telemetry itself is significantly impacting the sustainability metric. This granular analysis allows for the refinement of network designs to minimize wasted energy in large scale systems.

Although a specific embodiment for a measurement architecture 1500 for carrying out the various steps, processes, methods, and operations described herein is discussed with respect to FIG. 15, any of a variety of systems and/or devices may be utilized in accordance with embodiments of the disclosure. For example, the first unified computing system 1520 could be a virtual machine running on a hypervisor controlled by the first switch 1510. The elements depicted in FIG. 15 may also be interchangeable with other elements of FIGS. 1–14 and FIGS. 16–18 as required to realize a particularly desired embodiment.

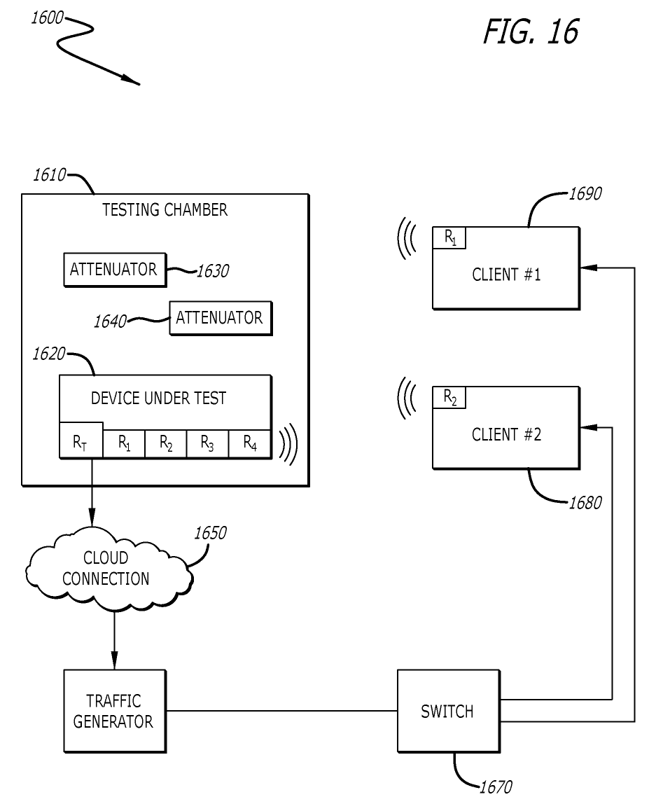

Referring to FIG. 16, an automated wireless test bed and standardization environment in accordance with various embodiments of the disclosure is shown. The automated wireless test bed and standardization environment 1600 can be configured to establish a controlled physical space for characterizing the energy efficiency of wireless networking hardware. In many embodiments, the automated wireless test bed and standardization environment 1600 can automate the generation of high fidelity power usage data for a plurality of radio configurations. This configuration can allow a system to create a standardized power-vs-temperature table that reflects real world operating conditions. Certain embodiments of the automated wireless test bed and standardization environment 1600 can be used to synchronize modular data points with a cloud-based network simulator to facilitate remote calibration of field devices.

In many embodiments, the automated wireless test bed and standardization environment 1600 can include a testing chamber 1610 that serves as an environmental enclosure for hardware characterization . The testing chamber 1610 can be configured with environmental controls to establish a predetermined temperature, such as a range between 23 degrees Celsius and 55 degrees Celsius . In various embodiments, the testing chamber 1610 can isolate the devices inside from external radio frequency interference to ensure the accuracy of electrical measurements. The testing chamber 1610 can also house auxiliary components such as temperature sensors and airflow controllers to maintain a stable testing climate. In certain embodiments, the testing chamber 1610 can be sized to accommodate a single wireless access point or a plurality of heterogeneous compute nodes.

In some embodiments, the automated wireless test bed and standardization environment 1600 can comprise a device under test 1620 that is positioned within the testing chamber 1610 . The device under test 1620 can be a network hardware unit comprising a plurality of radios, such as a first radio R1, a second radio R2, a third radio R3, and a fourth radio R4. In many embodiments, the device under test 1620 can include a real time telemetry interface RT to provide high fidelity reporting of its internal power states. The device under test 1620 can be operated under a fractional traffic load to isolate the power impact of specific internal components. In various embodiments, the device under test 1620 can be configured as a wireless access point, a modular switch, or a compute node for characterization .

In additional embodiments, the automated wireless test bed and standardization environment 1600 can include a first attenuator 1630 that is configured to simulate signal degradation . The first attenuator 1630 can be placed in a signal path within the testing chamber 1610 to reduce the strength of a wireless broadcast. In many embodiments, the first attenuator 1630 can be utilized to model the physical distance between networking nodes in a projected network topology. This configuration can allow the system to determine how much additional power the device under test 1620 consumes when its radios must overcome a weakened signal. In certain embodiments, the first attenuator 1630 can be an automated variable attenuator that adjusts in real time during a characterization cycle. As used herein, signal degradation encompasses any reduction in signal quality or strength experienced by a wireless transmission, including but not limited to signal attenuation caused by physical distance or obstacles, radio frequency interference, multipath propagation effects, and environmental noise. In various embodiments, signal degradation may be simulated within the testing chamber using one or more attenuators, interference generators or other signal-conditioning components.

In various embodiments, the automated wireless test bed and standardization environment 1600 can include a second attenuator 1640 that is configured to simulate further signal interference or obstacles . The second attenuator 1640 can be used in conjunction with other components to create a complex RF environment within the testing chamber 1610. In many embodiments, the second attenuator 1640 can be placed specifically to impact a discrete backhaul radio link for mesh mode power calculations. By adjusting the second attenuator 1640, the system can characterize the energy overhead required to maintain connectivity in poor environment conditions. In some embodiments, the second attenuator 1640 can be used to verify the performance of a unit under test when multiple radios are operating at different signal levels.

In further embodiments, the automated wireless test bed and standardization environment 1600 can include a cloud connection 1650 that serves as a bridge to external management systems . The cloud connection 1650 can be configured to synchronize standardized power usage data with a remote network simulator in real time. In many embodiments, the cloud connection 1650 can receive automated testing scripts and firmware updates for the device under test 1620. This connectivity can allow for the centralization of characterization data across multiple geographical test sites. In certain embodiments, the cloud connection 1650 can provide a secure portal for sustainability logic to retrieve high fidelity power data for customer install base modeling.

In still more embodiments, the automated wireless test bed and standardization environment 1600 can include a traffic generator 1660 which serves as the primary controller for data patterns. The traffic generator 1660 can be configured to provide an aggregate traffic load or a fractional traffic load to the device under test 1620. In many embodiments, the traffic generator 1660 can use specialized protocols to stress the radios of the device under test 1620 at varying throughput levels. The traffic generator 1660 can also monitor packet loss and latency to ensure the power data is captured only when the device is operating within expected performance bounds. In various embodiments, the traffic generator 1660 can be integrated with a network testing system to facilitate repeatable and standardized characterization cycles.

In additional embodiments, the automated wireless test bed and standardization environment 1600 can include a first switch 1670 that acts as a central distribution point for the testing infrastructure . The first switch 1670 can be configured to manage data paths between the traffic generator 1660 and various external client nodes. In many embodiments, the first switch 1670 can support high speed wired interfaces to ensure that the testing bottleneck remains the wireless interface being characterized. The first switch 1670 can also route telemetry data from the real time telemetry interface RT to the cloud connection 1650 for logging. In certain embodiments, the first switch 1670 can be configured with energy efficient ethernet settings to minimize the power footprint of the test bed itself.

In numerous embodiments, the automated wireless test bed and standardization environment 1600 can include a first client device 1680 that is configured to interact wirelessly with the device under test 1620. The first client device 1680 can be positioned outside of the testing chamber 1610 and can contain its own radio R2 to establish a link. In many embodiments, the first client device 1680 can run custom code to maintain stable communication with a specific radio on the device under test 1620. This configuration can allow the system to isolate the power draw of the first radio R1 by having the first client device 1680 act as a dedicated data sink. In various embodiments, the first client device 1680 can be a standard access point, a mobile station, or a specialized RF listener.

In additional embodiments, the automated wireless test bed and standardization environment 1600 can include a second client device 1690 that is configured to provide an additional wireless link. The second client device 1690 can include its own radio R1 and can be used to simulate a second user or a backhaul node in the environment. In many embodiments, the second client device 1690 can be used to evaluate how the device under test 1620 handles multiple simultaneous radio set activities. The second client device 1690 can also report its connection status back to the traffic generator 1660 via a secondary switch layer. In certain embodiments, the second client device 1690 can be used to verify the modular characterization of a backhaul radio for use in mesh mode simulations.

In a non-limiting example of the operation of the automated wireless test bed and standardization environment 1600, the testing chamber 1610 can be set to 40 degrees Celsius to simulate a data center environment. The traffic generator 1660 can then send a fractional traffic load to the device under test 1620, while the first attenuator 1630 is adjusted to simulate a 50 meter distance. The device under test 1620 can report its high fidelity power usage through the real time telemetry interface RT, which is routed via the first switch 1670 to the cloud connection 1650. This creates a modular data point that accurately represents the power impact of distance and heat on a specific radio set. This high fidelity data can then be utilized by a sustainability simulator to model a customer install base with high accuracy.

In another example embodiment, the automated wireless test bed and standardization environment 1600 can be used to characterize backhaul efficiency for a mesh network. The second client device 1690 can be configured as a backhaul node that communicates with the fourth radio R4 of the device under test 1620. The second attenuator 1640 can be adjusted to simulate a high interference environment, such as a crowded office space. As the device under test 1620 increases its power to maintain the backhaul link, the traffic generator 1660 captures the discrete power increase associated with that specific radio activity. This data is then used to generate a standardized power-vs-temperature table that assists in identifying architectural changes required for sustainability.

In yet another example, the automated wireless test bed and standardization environment 1600 can evaluate the linear scaling of power across multiple radios. The traffic generator 1660 can initiate an aggregate traffic load that is split equally between the first radio R1 and the second radio R2 of the device under test 1620. The first client device 1680 and the second client device 1690 can receive these splits while the sustainability logic monitors the real time telemetry interface RT. By comparing the power draw of two radios to the sum of each radio operating individually, the system can identify any internal non-linear scaling issues. This information can be critical for normalizing power data into a single unified sustainability metric for a heterogeneous platform.

Although a specific embodiment for an automated wireless test bed and standardization environment 1600 for carrying out the various steps, processes, methods, and operations described herein is discussed with respect to FIG. 16, any of a variety of systems and/or devices may be utilized in accordance with embodiments of the disclosure. For example, the testing chamber 1610 might be equipped with a robotic arm to dynamically move the client devices during a test. The elements depicted in FIG. 16 may also be interchangeable with other elements of FIGS. 1–15 and FIGS. 17–18 as required to realize a particularly desired embodiment.

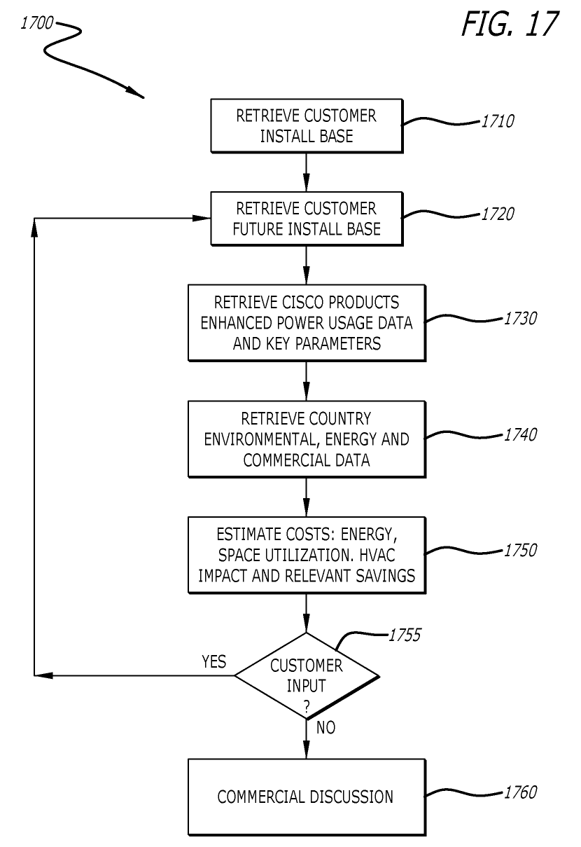

Referring to FIG. 17, a flowchart depicting a process 1700 for estimating costs and relevant energy savings in accordance with various embodiments of the disclosure is shown. The process 1700 can be configured to provide a manually driven logic flow for determining a return on energy metric based on a customer install base. In many embodiments, the process 1700 can utilize a library of modular component characterizations to evaluate the sustainability impact of a projected network topology . This configuration can allow a system to identify architectural changes required to meet a predetermined sustainability target.

In many embodiments, the process 1700 can retrieve customer install base (block 1710). This retrieval can involve collecting data representing a customer install base from various inventory management systems or hardware audit logs. For example, a sustainability logic might query a local network database to identify the specific model numbers and configurations of all active network devices. In another embodiment, the process 1700 can receive this data via a manual upload from a network administrator looking to evaluate a current deployment.

In a number of embodiments, the process 1700 can retrieve customer future install base (block 1720). This step can involve defining a projected network topology that reflects intended architectural changes or hardware upgrades. For instance, it is contemplated that a user could input a new network design to see how moving from a wired to a wireless mesh backbone impacts total power consumption. Alternatively, the process 1700 can automatically generate a future state model based on a desired performance goal or net zero emissions target.

In more embodiments, the process 1700 can retrieve Cisco products enhanced power usage data and key parameters (block 1730). This can involve accessing a library of modular component characterizations that contain high fidelity power data generated in a controlled testing environment. In a non-limiting example, the process 1700 can pull a standardized power-vs-temperature table for a specific radio set activity to ensure the simulation is highly accurate. In certain embodiments, this data can be retrieved from a cloud based network simulator to provide the most up to date modular radio unit information.

In further embodiments, the process 1700 can retrieve country environmental, energy and commercial data (block 1740). This information can include local utility rates, carbon tax associations, and specific gCO2e per kWh metrics for a given geographical location. For example, the process 1700 could retrieve the specific environmental impact data for a data center located in a region that relies heavily on renewable energy. In another embodiment, the sustainability logic can use this data to calculate the financial impact of energy consumption based on regional commercial energy schemes.

In additional embodiments, the process 1700 can estimate costs: energy, space utilization, HVAC impact and relevant savings (block 1750). This calculation can involve processing a modeled signal path against real time telemetry to determine a cumulative power sum. In various embodiments, the modeled signal path can comprise a plurality of hops. These hops can be split between one or more weighted standards or at least compatible with one or more applied systems in the field as those skilled in the art will recognize. For instance, the system can estimate the cooling costs saved by consolidating heterogeneous platforms into a more efficient unified computing system. In various embodiments, the process 1700 can also identify the savings associated with reducing the physical rack space required for a network deployment.

In still more embodiments, the process 1700 can determine if there is customer input (block 1755). If the process 1700 has determined that additional customer input is received, then the process 1700 can once again retrieve customer future install base (block 1720). This loop allows a user to refine the projected network topology based on the estimated costs and savings previously generated. However, if it is determined that no additional customer input is required, then some embodiments of the process 1700 can proceed to a final evaluation .

In numerous embodiments, the process 1700 can facilitate a commercial discussion (block 1760). This can involve generating a report that summarizes the return on energy metric and the one or more architectural changes required to meet a sustainability target . For instance, a commercial discussion might involve presenting a customer with a roadmap for hardware migration that reduces their total carbon footprint. In another embodiment, the process 1700 can export these results to a business management tool for further financial analysis and project planning.

Although a specific embodiment for a process 1700 for carrying out the various steps, processes, methods, and operations described herein is discussed with respect to FIG. 17, any of a variety of systems and/or processes may be utilized in accordance with embodiments of the disclosure. For example, any of the various processes described above can be performed in alternative sequences and/or in parallel in order to achieve similar results. The elements depicted in FIG. 17 may also be interchangeable with other elements of FIGS. 1–16 and 18 as required to realize a particularly desired embodiment.

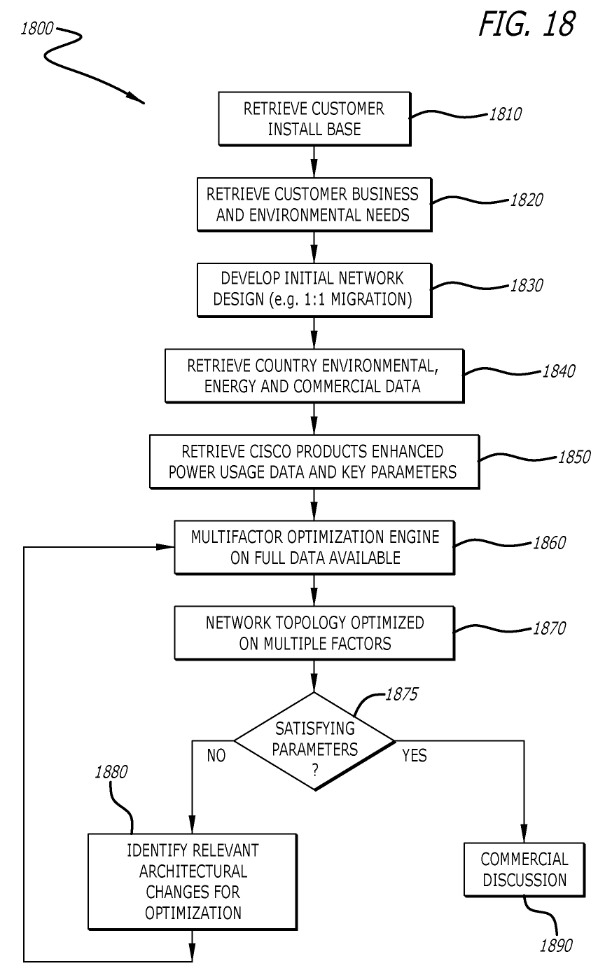

Referring to FIG. 18, a flowchart depicting a process 1800 for managing energy efficient ethernet settings in response to deployment on a network in accordance with various embodiments of the disclosure is shown. The process 1800 can be configured as an automated multifactor optimization engine flow for identifying architectural changes to meet a sustainability target. In many embodiments, the process 1800 can facilitate a deep analysis of a customer install base to determine a return on energy metric. This configuration can allow a system to move beyond simple reporting and into active network topology optimization.

In many embodiments, the process 1800 can retrieve customer install base (block 1810). This retrieval can involve collecting data representing a customer install base through automated network discovery or manual inventory imports. For example, a sustainability logic may query a network management system to determine the exact hardware revisions and port densities of existing switches. In another embodiment, the process 1800 can be configured to pull this information from a local area network database to ensure a high fidelity baseline is established.

In a number of embodiments, the process 1800 can retrieve customer business and environmental needs (block 1820). This step can involve defining specific sustainability goals, such as a net-zero emissions target or a fixed reduction in annual energy expenditures. For instance, a user might specify that the network must prioritize carbon dioxide reduction over initial capital expenditure. In further embodiments, the process 1800 can evaluate business requirements such as minimum throughput and maximum allowable latency for the projected network topology.

In more embodiments, the process 1800 can develop initial network design (e.g. 1:1 migration) (block 1830). This can involve creating a baseline model where the existing hardware in the customer install base is replaced with modern equivalents without changing the physical layout. In a non-limiting example, the process 1800 could simulate a direct replacement of older access points with newer modular radio units to measure the immediate energy delta. In certain embodiments, this initial design serves as the starting point for the automated optimization cycle.

In further embodiments, the process 1800 can retrieve country environmental, energy and commercial data (block 1840). This information can include real-time utility rates and specific carbon intensity metrics for the electrical grid in a given region. For example, it is contemplated that the process 1800 can pull data regarding local green energy incentives that might favor certain architectural changes. In another embodiment, the sustainability logic can utilize this data to convert a cumulative power sum into an estimated financial cost or carbon footprint.

In additional embodiments, the process 1800 can retrieve Cisco products enhanced power usage data and key parameters (block 1850). This involves accessing a library of modular component characterizations that contain high-fidelity power data and fractional power scaling data for individual radios. In a non-limiting example, the process 1800 can retrieve a standardized power-vs-temperature table specific to wireless radio activity. This high-fidelity data can then be used to override one or more software-reported power values that may be inaccurate.

In still additional embodiments, the process 1800 can utilize a multifactor optimization engine on full data available (block 1860). The multifactor optimization engine can process the modeled signal path against real-time telemetry from the customer install base to identify optimal configurations. For instance, the multifactor optimization engine can calculate a maximum return on energy and carbon dioxide calculation to justify specific hardware upgrades. In various embodiments, the multifactor optimization engine can simultaneously evaluate energy, space utilization, and HVAC impact savings.

In yet further embodiments, the process 1800 can ensure a network topology optimized on multiple factors (block 1870). This step involves generating a refined version of the projected network topology that balances performance with the predetermined sustainability target. For example, the system might suggest a mesh-mode configuration to eliminate the power draw of redundant wired switches in a low-traffic area. In another embodiment, the process 1800 can model signal attenuation as a dynamic variable to adjust the power weight of each modular radio unit.

In numerous embodiments, the process 1800 can determine if there are satisfying parameters? (block 1875). If the process 1800 has determined that the optimized design does not yet meet the required sustainability or performance goals, the process 1800 can identify relevant architectural changes for optimization (block 1880). For instance, the system might recommend consolidating heterogeneous platforms into a more efficient unified computing system. After these changes are identified, the process 1800 can once again utilize the multifactor optimization engine on full data available (block 1860) to refine the model further.

In various embodiments, the process 1800 can facilitate a commercial discussion (block 1890). This occurs once the process 1800 has determined that the network topology has satisfied the parameters for the sustainability target. In a non-limiting example, the system can generate a final report illustrating the projected savings and the identified architectural changes required for the customer install base. In certain embodiments, this data can be synchronized with a cloud-based network simulator for remote calibration and monitoring.

Although a specific embodiment for a process 1800 for carrying out the various steps, processes, methods, and operations described herein is discussed with respect to FIG. 18, any of a variety of systems and/or processes may be utilized in accordance with embodiments of the disclosure. For example, any of the various processes described above can be performed in alternative sequences and/or in parallel in order to achieve similar results. The elements depicted in FIG. 18 may also be interchangeable with other elements of FIGS. 1–17 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
a network interface configured to communicate with a plurality of network devices; and
a memory communicatively coupled to the processor, wherein the memory comprises a sustainability logic configured to:
retrieve data representing a customer install base;
retrieve a library of modular component characterizations;
model a cumulative power sum for a projected network topology;
determine a return on energy metric by processing a modeled signal path against real-time telemetry from the customer install base; and
identify one or more architectural changes to the customer install base required to meet a predetermined sustainability target.

2. The device of claim 1, wherein the modular component characterizations comprise fractional power scaling data for individual radios.

3. The device of claim 1, wherein the cumulative power sum is modeled by applying modular radio units from the library to the modeled signal path.

4. The device of claim 3, wherein the modeled signal path comprises a plurality of hops.

5. The device of claim 1, wherein the return on energy metric is processed via a multifactor optimization engine.

6. The device of claim 1, wherein the plurality of network devices comprises one or more heterogenous platforms.

7. The device of claim 6, wherein the one or more heterogeneous platforms include a compute layer comprising one or more unified computing systems and a network layer comprising one or more network switches.

8. The device of claim 7, wherein the sustainability logic is further configured to normalize power data across the compute layer and the network layer into a single unified sustainability metric.

9. The device of claim 1, wherein the predetermined sustainability target is a net-zero emissions target, and wherein the one or more architectural changes are identified based on a maximum return on energy and carbon dioxide calculation.

10. The device of claim 1, wherein the sustainability logic is further configured to override one or more software-reported power values from the customer install base with high-fidelity power data.

11. The device of claim 10, wherein the high-fidelity power data is retrieved via a real-time telemetry interface.

12. An apparatus, comprising:
a processor;
a testing chamber; and
a memory communicatively coupled to the processor, wherein the memory comprises a sustainability logic configured to:
direct the testing chamber to establish a predetermined temperature;
generate a fractional traffic load for a unit under test comprising a plurality of radios;
operate the unit under test within the testing chamber to simulate signal degradation;
generate a standardized power-vs-temperature table specific to wireless radio activity for the unit under test; and
synchronize the standardized power-vs-temperature table with a cloud-based network simulator.

13. The apparatus of claim 12, wherein the testing chamber comprises one or more environmental controls.

14. The apparatus of claim 13, wherein the testing chamber comprises a plurality of attenuators.

15. The apparatus of claim 14, wherein the signal degradation is simulated via the plurality of attenuators.

16. The apparatus of claim 12, wherein the standardized power-vs-temperature table is synchronized with the cloud-based network simulator to facilitate remote calibration of field devices.

17. The apparatus of claim 12, wherein the fractional traffic load is configured to isolate a power impact of a discrete backhaul radio for use in mesh-mode power calculations.

18. The apparatus of claim 12, wherein the sustainability logic is further configured to verify linear and non-linear power scaling for the unit under test based on a fractional splitting of an aggregate traffic load.

19. A method of network sustainability optimization, comprising:
retrieving, by a device, data representing a customer install base;
retrieving a library of modular component characterizations;
modeling a cumulative power sum for a projected network topology;
determining a return on energy metric by processing a modeled signal path against real-time telemetry from the customer install base; and
identifying one or more architectural changes to the customer install base required to meet a predetermined sustainability target.

20. The method of claim 19, further comprising modeling signal attenuation as a dynamic variable to adjust a power weight of each individual modular radio unit within the cumulative power sum.
